(19) United States
(12) Patent Application Publication
(10) Pub. No.: US 2024/0203615 A1
(43) Pub. Date: Jun. 20, 2024

(54) PROCESS, APPARATUS AND SYSTEM FOR THE PRODUCTION, SEPARATION AND PURIFICATION OF RADIOISOTOPES

(71) Applicant: SU-N Energy Holdings Ltd., Toronto (CA)

(72) Inventors: Suneel Navnitdas Parekh, Mumbai (IN); Platina Suneel Parekh, Mumbai (IN); Navnitdas Radhakishan Parekh, Mandsaur (IN)

(21) Appl. No.: 18/555,517

(22) PCT Filed: Mar. 18, 2022
(86) PCT No.: PCT/IB2022/052487

§ 371 Date: Oct. 14, 2023

(30) Foreign Application Priority Data
Apr. 15, 2021 (IN) 202121017481

(51) Int. Cl. G21G 1/00; B01D 7/00; B01D 15/20; C25C 1/22; G21G 1/04

(52) U.S. Cl. CPC G21G 1/001; B01D 7/00; B01D 15/203; C25C 1/22; G21G 1/04; G21G 2001/0089

(57) ABSTRACT

Processes, apparatuses, and systems for the production, separation and purification of radioisotopes for medical, industrial, agricultural, and energy applications are disclosed. The following operations are performed: selective adsorption of at least one radionuclide to a solid support and desorption of the at least one absorbed radionuclide by evaporation; or electrochemical separation of the at least one radionuclide by electrochemically depositing either the at least one radionuclide or the target material on a metallic electrode; or removing the target material by high temperature sublimation under vacuum or in an inert atmosphere, if the at least one radionuclide is less volatile than the target material.

### CROSS REFERENCE TO RELATED APPLICATIONS

This application is a national stage application of international patent application PCT/IB2022/052487, filed on Mar. 18, 2022, designating the United States and claiming priority from Indian patent application IN202121017481, filed Apr. 15, 2021, and the entire content of both applications is incorporate herein by reference.

### TECHNICAL FIELD

The present invention relates to methods, apparatus, device and systems for production, separation, and purification of radioisotopes.

The present disclosure relates generally to the field of chemistry, radiochemistry, radiobiology, Electrochemistry, nuclear physics, High Energy physics, pharmacology, medical physics, nuclear chemistry, and in particular, to process, apparatus and system for the production, separation and purification of alpha-emitting radionuclides, beta-emitting radionuclides, gamma/X-ray emitting radionuclides from transmuted resultant target material containing low mass, high mass, high density, rare earth, lanthanides, actinides and superheavy radionuclides produced by a process, wherein target elements (any one or more elements of the periodic table, e.g. hydrogen to uranium and transuranic elements) are reacted with paramagnetic and excited state mercury-based compound (based on Prior art PCT Publication number: WO 2016/181204 A1), for transmutation of elements and production of alpha-emitting radionuclides, beta-emitting radionuclides, Auger electrons, Electron capture emitting, gamma/X-ray emitting radionuclides. The produced radioisotopes will be used for nuclear medicine to cure life threatening diseases like cancer, heart attack and brain disorder, industrial applications, Alpha voltaic cells, beta voltaic cells, radioisotope based thermoelectric generators, radioisotopes based batteries for air, sea and road transportation system, energy for residential, commercial, industrial, transportation and for agriculture uses and other applications of energy, medical therapy, research, imaging and also several applications that are not medically related.

### BACKGROUND

In general, a radioactive isotope, also known as a radioisotope, radionuclide, or a radioactive nuclide, is an energetically unstable atom which will achieve a stable or more stable, lower-energy state (transitioning from a parent to a daughter state) by emitting energy or radiation in the form of alpha, beta, or gamma rays. An isotope is any element that has the same chemical properties and atomic number as a common element but different atomic weight. This unstable nucleus of a radioisotope can occur naturally or can be produced by transmutation process converting the target elements into many other new elements.

Radioisotopes are an effective tool used in several fields of research, radiopharmaceutical studies, industry, biology, environment, medicine, national security, agriculture, and life sciences. In the medical field, radioisotopes are used in the oncology, interventional radiology/cardiology and other related specialties for diagnosis, therapy, (tracers for diagnostic purposes), biochemical analysis of diseases e.g. radioimmunotherapy (RIT), biodistribution studies, PET imaging, Single-photon emission computed tomography (SPECT), gamma-spectrometry, Targeted alpha therapy (TAT), radioembolization, Auger-therapy etc. In industry, radioisotopes are used for measuring the thickness of plastic or metal sheets and might also be employed in place of large X-ray machines to examine manufactured metal parts for structural defects. Other significant applications include the use of radioisotopes to make atomic or nuclear batteries (alpha voltaic/beta voltaic batteries) such as radioisotope thermoelectric generator (RTG) which can be used as compact sources of electrical power for several energy-intensive equipment such as spacecrafts, pacemakers, medical implantable devices, automated scientific stations in remote areas and underwater systems. Some examples include Mossbauer spectroscopy, investigations of structures and reactions involving atomic nuclei, nuclear device detection, radioisotope thermoelectric generation and other nuclear batteries, nuclear non-proliferation, cancer therapies and diagnosis.

Industrial applications include neutron radiography, prompt gamma neutron activation analysis (“PGNAA”) and radioactive gas leak testing. Medical applications include radioactive medicines, brachytherapy, medical imaging and boron neutron capture therapy (“BNCT”).

There is presently no effective treatment of disseminated disease. While chemotherapy can be effective in combating metastatic disease over a short term, relapses ultimately occur due to cancer cell's ability to become resistant to the chemotherapy agent. Treatment of metastatic disease is the largest unmet medical need in cancer therapy, perhaps in all medical practice. The alpha-emitting radionuclides, when combined with an appropriate cancer-targeting vector, have the potential to be an effective therapy for metastatic cancer, and are also uniquely suited for use in treatment of compartmentally constrained cancers (e.g. ovarian and pancreatic cancers) and of minimal residual cancer after surgery. While there are a large number of unknowns in the development of targeted alpha therapy agents, their use has the potential to make the substantial improvements in treatment outcomes for many cancers.

List of the radioisotopes and what they can be used for:
³H, ⁷Be, ⁸Be, ¹⁰Be, ¹⁰B, ¹⁴C, ¹³N, ¹⁵O, ¹⁸F, ²⁸Mg, ²⁶Al, ³²Si, ³²P, ³³P, ³⁶Cl, ³⁷Ar, ³⁹Ar, ⁴²Ar, ³²K, ⁴²K, ⁴³K, ⁴¹Ca, ⁴⁵Ca, ⁴⁶Ca, ⁴⁷Ca, ⁴⁸Ca, ⁴⁴Sc, ^{44m}Sc, ⁴⁶Sc, ⁴⁷Sc, ⁴⁴Ti, ⁵¹Cr, ⁵²Mn, ⁵⁴Mn, ⁵⁶Mn, ⁵²Fe, ⁵⁴Fe, ⁵⁵Fe, ⁵⁹Fe, ⁶⁰Fe, ⁵⁵Co, ⁵⁶Co, ⁵⁷Co, ⁵⁸Co, ⁶⁰Co, ⁵⁹Ni, ⁶³Ni, ⁶²Cu, ⁶⁴Cu, ⁶⁷Cu, ⁶²Zn, ⁶⁵Zn, ⁷²Zn, ⁶⁸Ga, ⁶⁸Ge, ⁷²As, ⁷⁷As, ⁷²Se, ⁷³Se, ⁷⁵Se, ⁷⁹Se, ⁸²Se, ⁷⁵Br, ⁷⁶Br, ⁷⁷Br, ⁷⁵Kr, ⁷⁶Kr, ⁷⁷Kr, ^{81m}Kr, ⁸⁵Kr, ⁸¹Rb, ⁸²Rb, ⁸⁷Rb, ⁸²Sr, ⁸³Sr, ⁸⁵Sr, ⁸⁹Sr, ⁹⁰Sr, ⁸⁵Y, ⁸⁶Y, ⁸⁷Y, ⁸⁸Y, ⁹⁰Y, ⁹¹Y, ⁸⁹Zr, ⁹³Zr, ⁹⁴Zr, ⁹⁶Zr, ⁹⁰Nb, ⁹³Nb, ⁹⁵Nb, ⁹³Mo, ⁹⁹Mo, ⁹⁹Tc, ^{99m}Tc, ⁹⁷Ru, ¹⁰³Ru, ¹⁰⁶Ru, ¹⁰³Pd, ¹⁰⁷Pd, ¹¹¹Ag, ¹⁰³Cd, ¹¹³Cd, ¹¹¹In, ¹¹³Sn, ^{117m}Sn, ¹²⁶Sn, ¹¹⁹Sb, ¹²⁵Sb, ^{121m}Te, ¹²⁷Te, ¹²⁹Te, ¹²¹I, ¹²²I, ¹²³I, ¹²⁴I, ¹²⁵I, ¹²⁶I, ¹²⁹I, ¹³⁰I, ¹³¹I, ¹²¹Xe, ¹²²Xe, ¹²³Xe, ¹²⁵Xe, ¹²⁷Xe, ^{129m}Xe, ^{131m}Xe, ¹³³Xe, ^{133m,g}Xe, ¹³⁵Xe, ¹³⁴Cs, ¹³⁵Cs, ¹³⁷Cs, ¹²⁸Ba, ¹³⁷Ce, ¹³⁹Ce, ¹⁴¹Ce, ¹⁴⁴Ce, ¹³⁴Ce/La, ¹³²La/¹³⁵La, ¹⁴³Pr, ¹³⁸Nd/Pr, ¹⁴⁰Nd/Pr, ¹⁴⁷Nd, ¹⁴⁷Pm, ¹⁴⁹Pm, ¹⁴²Sm/Pm, ¹⁴⁷Sm, ¹⁵³Sm, ¹⁵⁴Eu, ¹⁵⁵Eu, ¹⁴⁷Gd, ¹⁴⁸Gd, ¹⁴⁹Gd, ¹⁵⁷Gd, ¹⁴⁹Tb, ¹⁵²Tb, ¹⁵⁵Tb, ¹⁶¹Tb, ¹⁵⁷Dy, ¹⁵⁹Dy, ¹⁶⁵Dy, ¹⁶⁶Ho, ¹⁶⁵Er, ¹⁶⁹Er, ¹⁶⁵Tm, ¹⁶⁷Tm, ¹⁶⁹Yb, ¹⁷⁷Yb, ¹⁷²Lu, ¹⁷⁷Lu, ¹⁷²Hf, ¹⁷⁵Hf, ¹⁷⁸Ta, ¹⁷⁸W, ¹⁸⁸W, ¹⁸⁶R, ¹⁸⁸Re, ¹⁸⁸Ir, ¹⁸⁹Ir, ¹⁹⁰Ir, ¹⁹²Ir, ^{192m}Ir, ¹⁹³Ir, ¹⁹⁴Ir, ^{194m}Ir, ¹⁹⁵Au, ¹⁹⁸Au, ¹⁹⁴Hg, ¹⁹⁵Hg, ¹⁹⁷Hg, ²⁰¹Tl, ²⁰²Tl, ²¹⁰Pb, ²¹¹Pb, ²¹²Pb, ²⁰⁶Bi, ²¹⁰Bi, ²¹¹Bi, ²¹²Bi, ²¹³Bi, ²¹⁰Po, ²¹¹Po, ²¹²Po, ²¹³Po, ²¹⁴Po, ²¹⁵Po, ²¹⁸Po, ²⁰⁴At, ²⁰⁵At, ²⁰⁶At, ²⁰⁷At, ²⁰⁸At, ²⁰⁹At, ²¹⁰At, ²¹¹At, ²¹⁸At, ²¹⁹Rn, ²²⁰Rn, ²²¹Rn, ²²²Rn, ²²⁰Fr, ²²¹Fr, ²²³Ra, ²²⁴Ra, ²²⁵Ra, ²²⁶Ra, ²²⁵Ac, ²²⁷Ac, ²⁰¹Th, ²²⁷Th, ²²⁸Th, ²²⁹Th, ²³⁰Th, ²³²Th, ²³⁴Th, ²³¹Pa, ²³⁴Pa, ²³³U, ²³⁴U, ²³⁵U, ²³⁶U, ²³⁸U, ²³⁷Np, ²³⁸Pu, ²³⁹Pu, ²⁴⁰Pu, ²⁴¹Pu, ²⁴²Pu, ²⁴⁴Pu, ²⁴¹Am, ^{242m}Am, ²⁴³Am, ²⁴²Cm, ²⁴³Cm, ²⁴⁴Cm, ²⁴⁵Cm, ²⁴⁷Cm, ²⁵¹Cf, ²⁵²Cf

Nuclear medicine using radioisotopes is extremely useful for clinical cancer diagnosis, prognosis, and treatment. Cancer is the second leading cause of death worldwide, accounting for 9.6 million deaths annually. Prostate, lung, stomach, colorectal and liver cancer are the most common types of cancer in males while colorectal, stomach and breast are the most common among females. The global cancer burden is estimated to have risen to 18.1 million new cases and 9.6 million deaths annually. Worldwide, the number of people that are alive within 5 years of cancer diagnosis is around 43.8 million.

Radiopharmaceutical therapy (RPT)/radiopharmaceuticals have emerged as a novel therapeutic tool for the diagnosis and therapy of various diseases including cancer. RPT allows for the delivery of radioisotopes bound to tumour-selective biological molecules to specific tumour-associated targets including organs, tissues or cells within the human body.

Peptide receptor radionuclide therapy (PRRT) is one type of radiopharmaceutical. This therapy involves combining a peptide with a radioactive substance to make a radiopeptide. When given, this radiopeptide further attaches to the target cancer cells and delivers a high radiation dose directly to the cells.

Unlike traditional radiation therapy, radiation in RPT is administered systemically or locoregionally which is similar to chemotherapy or a biologically targeted therapy. Radiopharmaceutical therapy has fewer side effects than traditional radiation therapy and is better equipped to target cancer cells. RPT may be effective on both isolated tumors and on metastatic cancer that has spread throughout the body. This radiation-induced killing of cancer cells or their microenvironment either directly or using delivery vehicles that either bind specifically to endogenous targets or accumulate by a wide variety of physiological mechanisms, enable a targeted therapeutic approach. Apart from cancer, RPT also has applications in several non-oncological disorders including rheumatoid arthritis and polyarthritis.

Another type of radiopharmaceutical is radioimmunotherapy which uses monoclonal antibodies (mAb) conjugated to radioisotopes to deliver cytotoxic radiation to target cancer cells, providing a specific internal radiotherapy.

For radioimmunotherapy (RIT), radioisotopes which decay with particulate and non-penetrating radiations such as alpha particles, beta particles, auger, or low-energy X-rays are utilised. The site where radiation energy will be deposited and the distance over which the energy is deposited at the tissue level, also known as linear energy transfer (LET), are both essential since not all components of cells and tissues are equally sensitive. LET refers to the number of ionizations caused by that radiation per unit of distance travelled. Apart from Linear energy transfer (LET), relative biological effectiveness (RBE) is also an essential radiobiologic concept. Relative biological effectiveness (RBE) is the ratio of biological doses required by two different types of ionising radiation to cause the same level of biological effect.

The biochemical and physical characteristics of a radionuclide need to be considered when selecting a radioactive isotope for clinical application. Biochemical characteristics include tissue targeting, retention of radioactivity in the tumour, in vivo stability, and toxicity. Furthermore, the choice of radionuclide used for RIT depends on its distinct radiation characteristics and the type of malignancy or cells targeted. Physical characteristics include emission type, emission energy, physical half-life, daughter products, radio nuclidic purity and method of production.

The correct selection of antibody combinations and isotope is essential for making radioimmunotherapy a standard therapeutic modality because the alpha- and beta-emitting particles emitted during radioisotope decay differ in significant ways. Alpha-emitting radioisotopes have a short path length (50-80 μm) and a high linear energy transfer (LET) (˜100 keV/μm). Therefore, targeted alpha therapy allows for more specific cancerous cell killing with less damage to surrounding healthy tissues compared to beta-emitting radioisotopes. Alpha-emitting radioisotopes have a high LET deposit within a small range of tissues which spares the surrounding healthy tissues and keeps the radioactive dose within the target organ to be treated. Therefore, α-particles may be better suited to the treatment of micrometastatic, microscopic or small-volume disease since their short range and high energies potentially offer more efficient and specific killing of tumour cells. Based on these considerations, α-particle therapy has been investigated in the treatment of various diseases including lymphomas, gliomas, leukaemia's, peritoneal carcinomatosis and melanoma. Radioimmunotherapy using alpha-emitting radioisotopes such as ²¹¹At, ²¹³Bi, ²²⁵Ac and ²²⁴Ra has shown activity in several in vitro and in vivo experimental models as well as in clinical trials.

Targeted Alpha Therapy (TAT), in which an α-particle emitting radionuclide conjugated to a carrier (normally an antibody) is specifically directed to the biological target, is gaining more attention. The alpha-particle is a naked 4He nucleus with a +2 charge; its extreme mass compared to that of electrons suppresses deflection of the particle and its track is almost linear. α-particles have a high LET (80 keV/μm) and a moderate pathlength (50-100 μm), giving them an effective range of less than 10 cell diameters, i.e., within microscopic tumour cell clusters. This short range of emitting alpha-particles minimises unwanted irradiation of normal tissue surrounding the targeted cancer cells of interest (minimal toxicity to surrounding healthy cells). These properties make targeted alpha-particle therapy ideal for the elimination of minimal residual or micro metastatic disease. Importantly, α-particle lethality is associated with double stranded DNA breaks and DNA cluster breaks and is therefore much more difficult to repair than β-particle damage. While only a few alpha-particle decays are required to attain a single cell kill probability of 99.99%, several thousand beta-particle decays are required to achieve the same kill probability. As alpha-particles cannot be directly imaged in vivo, the γ-photons, characteristic X-rays, or bremsstrahlung radiation that accompanies the parent radionuclide's decay are often used for quantifying target uptake, dosimetry and therapy response. Indirect mechanisms increasing alpha-particle lethal potency including: the crossfire effect (CF), the radiation-induced bystander effect (RIBE) and the abscopal effect (AbsE). Preclinical and clinical studies using α-emitters have been carried out for various cancers including recurrent ovarian cancer, recurrent brain tumour, non-Hodgkin lymphoma, human epidermal growth factor receptor-2 (HER-2) positive cancers, metastatic melanoma, skeletal metastases in prostate cancer, prostate and neuroendocrine tumours.

β-particle therapy is better suited for bulky tumour or large-volume disease than micro metastatic tumour cells since β-particles have a low LET (˜0.2 keV/μm) and long path length (0.05-12 mm). This may produce nonspecific cytotoxic effects by destroying surrounding normal healthy cells along their long electron track instead of simply depositing their main energy into the micro metastatic tumour that they are meant to target. Auger electrons (AEs) are very low energy electrons emitted by radioisotopes that decay by electron capture (e.g. ⁶⁷Ga, ¹¹¹In, ^{195m}Pt, ^{99m}Tc, ¹²⁵I and ¹²³I). This energy is deposited over a short pathlength of 2-500 nm, resulting in medium linear energy transfer (LET) of 4-26 keV/μm, such that lethal damage is caused majorly within single cancer cells. They can also kill cancer cells by damaging the cell membrane or through a cross-dose or bystander effect. Thus, the ability of AE-emitting radiotherapeutic agents and Koster-Kronig electron transitioning radiotherapeutic agents to emit multiple low energy and short-range electrons with high LET makes them a great candidate for the treatment of cancer.

It can also be advantageous for the therapeutic radionuclide, or a complementary theragnostic radionuclide, to emit positrons (β+) or gamma (γ) radiation. This enables positron emission tomography (PET) or single photon emission tomography (SPECT) imaging and visualization of radiopharmaceutical distribution within a patient's body, permitting treatment monitoring.

Internal radiotherapy therapy on the other hand is administered by planting a small radiation source, usually a gamma or beta emitter, in the target area. Brachytherapy or Short-range radiotherapy is becoming the main means of treatment. Iodine-131 is used to treat non-malignant thyroid disorders and thyroid cancer. Iridium-192 wire implants are used in the head and breast and removed after administering the correct dosage. Iodine-125 or Palladium-103 are used in brachytherapy for early-stage prostate cancer in the form of permanent implant seeds. Alternatively, radioactive Iridium-192 in the form of needles can be inserted for 15 minutes. Brachytherapy procedures are cost effective, more localised to the target tumour and thereby give less radiation to the body.

Over the years, radiopharmaceutical therapy has become more successful in treating persistent disease with very low toxic side effects.

Radionuclides also hold great importance in the field of sterilisation. Several medical products are sterilised using gamma rays from a Co-60 source which is cheaper and more effective than traditional steam heat sterilisation. Items sterilised using radiation are indefinitely sterile as long as the seal is not broken. Apart from syringes, medical products sterilised by radiation include cotton wool, heart valves, burn dressings, surgical gloves, plastic, surgical equipment, rubber sheets, and bandages.

As of today, the quantity of radioisotopes that can be produced globally using the existing production routes is not enough to meet the demand. Apart from being insufficient for pre-clinical or clinical trials, the current methods of production are not enough for commercial product development, including licensing and approval.

The present invention will be able to produce large quantity of alpha-emitting radionuclides to meet the global demand, curing millions of people suffering from various life-threatening diseases.

Targeted alpha therapy (TAT) will play an important role in the treatment of disseminated, chemo resistant and radioresistant metastatic disease, against which there are no efficacious treatment options.

However, currently a limited number of radionuclides are applicable to TAT. However, to tackle various forms of cancer, several alpha-emitting radioisotopes should be made available to a broader community. Currently, only 1.7 Ci (63 Gbq) of ²²⁵Ac can be produced annually worldwide using the existing sources of ²²⁹Th, which is not sufficient to meet the demand for ²²⁵Ac. The limited amount of ²²⁵Ac produced annually is sufficient for pre-clinical or clinical trials, but is not enough for commercial product development, including licencing and approval. According to recent estimates, the minimum required annual production of ²²⁵Ac is ≈100-200 Ci/year, assuming 1 mCi per patient and 100,000-200,000 patients per year.

The present invention and its subject matter of claims will be able to produce large quantity of alpha-emitting radionuclides such as ²¹¹At, ²¹³Bi, ²²⁵Ac and ²²⁴Ra to meet global demand, curing millions of people suffering from cancer.

There is an ongoing effort to develop efficient and more simple production methods for alpha-emitting radioisotopes to make them widely available. The present invention is capable to make available alpha-emitting radionuclides to wider community for betterment of our society in a cost-effective way.

The production of major commercially essential isotopes is currently limited and the irradiation sites in nuclear research reactors are expensive and will become even scarcer in the future due to age-related shutdown of reactors. There is a dire need for expansion of robust and high-yield production routes to enhance the availability and alpha, beta- and gamma/X-ray radioisotopes.

Currently, there are not enough alpha-emitting radioisotopes available for any preclinical or clinical trials. Hence, there is a need to produce radioisotopes that are in short supply since it is the supply itself that holds scientific research back.

The presently used methods in radioisotope production have reached their limits and there is a strong need for improved methods particularly in terms of providing higher isotopic purity, specific activity, and a wider range of available radionuclides.

For a widespread clinical application of radioisotopes, the availability of alpha-emitting radioisotopes must be increased significantly and a cheaper production scheme for the same is needed.

The present invention would allow for production of additional alpha, beta, and gamma-/X ray emitting radioisotopes which would further allow for a larger scale of preclinical and clinical trials. Our invented technology would also support more preclinical studies and clinical trials of the radioisotopes. This could lead to a widespread use of TAT and have several other applications in the industrial, medical and research field and as cancer therapy.

The present invention opens pathways for mass production of several rare isotopes which hitherto have not been available on the market and are now much in demand.

### SUMMARY

For this reason, it is an object of the present invention to provide a method, apparatus, device and system for the production, separation, and purification of radioisotopes, especially of carrier-free or non-carrier added radionuclides. This will be able to fulfill the global demand for existing radioisotopes that are essential for several medicine, life science, industrial, agricultural and research applications but are currently in short supply; and also, several radioisotopes that till now have not been available on the market but are in much demand and also to produce novel radioisotopes for new medical applications.

This object is satisfied through the production, separation, and purification of radioisotopes as per method, apparatus, device, and system described herein.

The method, apparatus, device, and system comprise, separately or in at least partial combination, the steps and equipment as follows:
Hot Cells, Semi Hot Cells, Glove Box, Radioisotopes Production System,
Radionuclide Transport system, Overhead crane, Radionuclide Separation System,
Radionuclide Purification System, Measuring devices for a, b, y/X-rays, n,
Radiation Shielding, Safety equipment, Quality control, Support equipment,
Packaging System for Radionuclides, Control Room, Electrification, Analytical Labs, Instrumentation, Controls, Safety Interlocks, Security System, Ventilation System, Consumables, Mechanical equipment, and Miscellaneous equipment.
Vacuum Chamber with Heating arrangements and crucible for melting of target elements from Hydrogen to Uranium and Trans Uranic Elements. (one or more elements of the periodic table or in combination thereof)
Paramagnetic and excited state mercury-based compound ((Based on Prior art PCT Publication number: WO 2016/181204 A1) or (any other prior art for fabrication of paramagnetic and metastable excited state mercury based compound)), as a source of energy for transmutation of elements and production of alpha, beta, gamma and X ray emitting radioisotopes.
Target elements any one or more elements of the periodic table from hydrogen to uranium and transuranic elements and in combination thereof.
Methods for separation of the desired radioisotopes from resultant target material
Methods of purification of the desired radioisotopes from the resultant target material
Production of capsules/vials containing the desired radioisotope
The radioisotopes can also be collected by implantation into micro/nanoparticles, macromolecules, microspheres, macroaggregates, ion exchange resins or matrices used in chromatographic systems
Quality control methods: Quality control methods used for checking open radioisotopes include measurement of: radioactivity with ion-chamber based dose calibrators; imaging detectors for identification and quantification of alpha, beta and gamma radiation; radio nuclidic purity by gamma ray spectroscopy, and radiochemical purity by TLC, HPLC, GC system, Particle counter, Pyrogen testing equipment, electrophoresis as well as control of the microbiological purity by growth on culture medium and LAL test.

Fabrication of paramagnetic and metastable excited state mercury-based compound and using it as a source of energy for transmutation of elements (based on prior art PCT Publication number WO 2016181204 A1). Paramagnetic and metastable excited state mercury-based compound is reacted with the nucleus of target element/s (target element can be any one or more elements of the periodic table from hydrogen to uranium and trans uranic elements), and target element/s are transmuted into many new elements including low mass, high mass, high density, rare earth and super heavy elements, achieving very high transmutation rates, which is many times of all other technologies currently being used for transmutation of elements, e.g. Accelerated Driven System (ADS), Particle Accelerator etc.

High Purity Germanium (HPGe) provides sufficient information to reliably and accurately identify radionuclides from their passive gamma ray emissions and can also be used as an X-ray detector.

A scintillator such as zinc sulphide is used for alpha particle detection, whilst plastic scintillators are used for beta detection. For detection of beta particles, organic scintillators can also be used. Pure organic crystals include crystals of anthracene, stilbene and naphthalene, but are not limited to it.

Main technological processes range from common chemical treatments to radiochemical separation techniques e.g. ion-exchange, liquid chromatography, distillation, extraction etc. These procedures are supplemented by controlled dilution of the radioactive solution to adjust its concentration and delivery of the stock solution.

Quality control methods used for checking open radioisotopes include measurement of: radioactivity with ion-chamber based dose calibrators; radio nuclidic purity by gamma ray spectroscopy, and radiochemical purity by TLC, HPLC, electrophoresis as well as control of the microbiological purity by growth on culture medium and LAL test.

Radiochemical separation can be performed by separation methods as standalone unit or as an integrated system; such methods include solid phase extraction (SPE), resin chromatography, liquid-liquid extraction (LLE), precipitation, distillation (dry or wet distillation) and sublimation, all of which need to be applied as directly as possible to the irradiation mixture.

The Liquid-Liquid Extraction process is based upon the selective partitioning of solutes between two immiscible solvent phases, usually an aqueous solution (i.e., acids, bases, or salts) and an organic solvent (e.g., ketones, amines, and ethers), while controlling volumes of the phases, pH, composition of the aqueous phase and mixing time. It has a high selectivity even at low concentrations because partition conditions may be easily changed to provide radioisotope yields that are generally free of radio nuclidic and chemical impurities. LLE can be done quickly, which is especially important when separating isotopes with shorter half-lives, and it is also reasonably easy to automate.

LLE is usually followed by evaporation of the extracting solvent, purification of the radioisotope from the organic phase via back extraction in aqueous phase or SPE/chromatography and finally dissolution into a solution phase suitable for subsequent radiolabelling or injection.

Dry distillation removes the target material by evaporating it in an inert environment or under vacuum, leaving only the less volatile elements behind. Depending on the element, different approaches can be used to recover the desired nuclei from the residue.

Isotope separation techniques can be divided into three types based on:
Atomic weight of the isotope directly
Small differences in chemical reaction rates as a result of different atomic weights
Properties such as nuclear resonance, which are not directly connected to atomic weight

Other techniques of separation and purification:
High temperature desorption under vacuum or inert gases
High temperature sublimation under vacuum or inert gases
Adsorption on suitable substrates
Desorption by chemical evaporation
Harvesting by Selective Adsorption:
Noble gases, halogens, Thallium are separated in a magnetic sector field
Mass separation is performed using a mass selective device including a Wien-filter, radiofrequency quadrupole and a magnetic sector field but not limited to it
Precipitation
Electrochemical separation
Extraction
Cation exchange chromatography
Anion exchange chromatography
Thermo chromatography
Gas chromatography
Electrodeposition
Sublimation
Ion Exchange
Extraction chromatography
Wet chemical approaches
Diffusion
Laser based separation, for instance, AVLIS (atomic vapor laser isotope separation); MLIS (molecular laser isotope separation); SILEX (Separation of isotopes by laser excitation); Trojan wave packet formation
Gravity separation, for instance, cryogenic distillation
Centrifugal separation, for instance, using a Zippe type centrifuge; Centrifuging plasma can separate isotopes as well as separating ranges of elements for radioactive waste reduction, nuclear reprocessing, and other purposes. The process is called “plasma mass separation” and the devices are called “plasma centrifuge” or “plasma mass filter”
Electromagnetic separation
Radio chromatographic separation
Acid treatment of the target followed by solvent extraction
Distillation
Small column-based or Cartridge-extraction chromatography methods
Electro filtration method
Precipitation
Electroamalgamation
Resin-separation methods (for instance novel extraction chromatographic (EXC) resins)
Column chromatography
Electrochemistry
Multicolumn Selectivity Inversion Generator, which involves a primary separation column selectively retaining the desired daughter radionuclide from a solution of the parent or parents, followed by stripping the daughter radionuclide from the primary column, and immediately passing the daughter through a secondary separation column or guard column which retains the parents while the daughter elutes unrestrained without feed adjustment.
Fixed column generator approach wherein the parent isotope is permanently sorbed on the sorbent column while the daughter product is periodically eluted

All of the above methods can be utilized either alone or in combination for the separation and purification of radionuclides, depending on the route of their production, the radionuclides of interest and presence of any impurities.

The carrier free radioisotope can be obtained in the atomic form/ion or as a molecular ion in corresponding sideband (oxide, halide, fluoride)

The present invention relates to a device, method, system and apparatus for production, separation, and purification of radioisotopes, comprising, separately or in at least partial combination, features as follows, i.e.
1. Hot Cell, Semi Hot Cell, Glove box, Shielded Room and Shielded Area
2. Paramagnetic and Excited State Mercury Based Compound (based on prior art PCT Publication number WO 2016181204 A1) or any prior art, wherein mercury-based compound is paramagnetic and is present in the excited state or mercury-based compound is metastable.
3. The target elements include all elements of the periodic table from Hydrogen to Uranium and Transuranic elements, or any combination thereof in molten state, liquid state, solid state and gaseous state and in any forms of the target elements (e.g. oxides, halides, fluorides etc.) but not limited to it.
4. Vacuum melting furnace or Melting furnace, having melting temperature of melting point of target elements from Hydrogen to Uranium and Transuranic elements.
5. Production of Radioisotopes using paramagnetic and excited state mercury-based compound as a source of energy for transmutation of target elements, (target elements can be any one or more elements of periodic table or in combination thereof)
6. After transmutation process, resultant target material containing radioisotopes are taken for mass separation.
7. Using methods for separation of desirable radioisotopes from resultant target material
8. Using method for purification of radioisotopes
9. Measuring of activity and its half-life of radioisotopes
10. Quality check
11. Packing in vial of radioisotopes

While the invention is susceptible of various modifications and alternative forms, some non-limiting embodiments, provided for explicatory purposes, are described below in detail.

It should be understood, however, that there is no intention to limit the invention to the specific embodiments disclosed, but, on the contrary, the intention of the invention is to cover all modifications, alternative constructions and equivalents falling within the scope of the invention as defined in the claims.

Therefore, in the description below the use of “for example”, “etc”, “or”, “otherwise” indicates non-exclusive alternatives without limitation unless otherwise defined; the use of “also” means “including, but not limited to” unless otherwise defined; the use of “including/comprising” means “including/comprising but not limited to,” unless otherwise defined.

Fabrication of paramagnetic and excited state “metastable” mercury-based compound and using it as a source of energy for transmutation of elements (based on prior art PCT Publication number WO 2016181204 A1). Paramagnetic and excited state “metastable” mercury-based compound is reacted with the nucleus of target element/s (target element can be any one or more elements of the periodic table from hydrogen to uranium and trans uranic elements), and target element/s are transmuted into many new elements including low mass, high mass, high density, rare earth and super heavy elements, achieving very high transmutation rates, which is many times of all other technologies currently being used for transmutation of elements, e.g. Accelerated Driven System (ADS), Particle Accelerator etc.

Linear energy transfer (LET) and relative biologic effectiveness (RBE) are essential radiobiologic concepts. LET refers to the number of ionizations caused by that radiation per unit of distance traveled. α-Particles have a high LET (approximately 100 keV/μm), whereas, β-particles have a far lower LET (0.2 keV/μm).

Because of the short pathlength (50-80 micron) and high linear energy transfer (approximately 100 keV/micron) of alpha-emitting radioisotopes, targeted alpha-particle therapy offers the potential for more specific tumour cell killing with less damage to surrounding healthy tissues than beta-emitters. These properties make targeted alpha-particle therapy ideal for the elimination of minimal residual or micro metastatic disease. Radioimmunotherapy using alpha-emitters such as ²¹³Bi, ²¹¹At, ²²⁴Ra and ²²⁵Ac has shown activity in several in vitro and in vivo experimental models. Clinical trials have demonstrated the safety, feasibility, and activity of targeted alpha-particle therapy in the treatment of small-volume and cytoreduced disease.

Radiochemical separation methods based on liquid-liquid extraction and ion exchange have been specifically developed or modified to suit remote control operations in a hot cell.

Precipitation has long been among the tools most widely used by radiochemists in their work on the separation and analysis of radioactive elements. The possibility of incorporating a variety of chemical manipulations to achieve the required separations is a major advantage of this technique.

One of the methods for the removal of cations from aqueous media is based on the use of fixed bed columns filled with cation exchange resins. Conventional cation exchange resins are based on a poly(styrene-divinylbenzene) matrix with sulphonic acid functional groups. Such resins are routinely used along with anion exchange resins for the demineralization of water. Because such resins have low selectivity differences between different cations, they can be used to selectively recover a single cation by using complexants to prevent the exchange of other cations or by selectively stripping the desired cation from the loaded column.

Extraction chromatography is a simple column chromatographic technique that uses small granules or beads 50-150 μm in size that have selective ligands sorbed on or covalently bound to porous solid supports.

Radionuclide gases can be extracted by exposing the air-saturated water to a gas phase having lower partial pressures of argon and krypton, which can be achieved either by applying a partial vacuum or by putting the water in contact with a pure and inert gas such as helium or N2 in which argon and krypton partial pressures are nominally zero. During these gas extraction processes, the elemental and isotopic ratios of noble gases are expected to fractionate depending on their respective solubilities.

Radioisotopes play a key role in several fields of research, medicine and life science ranging from medical treatments as a part of nuclear medicine, oncology, interventional radiology/cardiology and other related specialties, diagnosis, radiotherapy, biochemical analysis along with diagnostic and therapeutic pharmaceuticals, national security and basic research. Some examples include investigations of structures and reactions involving atomic nuclei, Mossbauer spectroscopy, radio-thermoelectric generation and other nuclear batteries, nuclear device detection, nuclear non-proliferation, cancer diagnosis and therapies. Radioisotopes are an effective tool used in radiopharmaceutical sciences, industrial applications, agriculture, environmental tracing, and biological studies.

In the medical field, several radioisotopes are used for the treatment and diagnosis of various forms of cancer. Radioisotopes that are capable of emitting alpha particles, such as radium-223, actinium-225 and bismuth 213), are particularly advantageous in treating cancers because they provide highly ionizing radiation that does not penetrate far from the radioisotope. If the alpha emitter is placed near a tumour site or cancer cell, its effects are localized to those sites without significantly affecting healthy, Surrounding tissue. For instance, Bi-213 decays via a daughter isotope, polonium-213 producing alpha emissions that have an extremely high energy of about 8.4 MeV.

The radioisotopes generated using the present invention can be used in the form of an atomic battery, nuclear battery, radioisotope battery or a radioisotope generator wherein energy from the decay of a radioactive element is used for the generation of electricity. These radioisotope batteries can be classified into thermal converters and non-thermal converters. Thermal converters convert some of the heat generated by the radioactive decay into power/electricity. An example of this is the radioisotope thermoelectric generator or RTG which is often used in spacecraft, satellites, weather stations and navigation beacons. RTG is a type of nuclear battery which uses an array of thermocouples to convert heat released by decay of radioactive elements into electricity by the See beck effect.

Non-thermal converters extract energy directly from the radiation being emitted, before it is degraded into heat. These are more suitable for use in small scale applications since they do not require a thermal gradient to obtain and therefore can be miniaturised. The most notable example includes the radio voltaic device.

A radio voltaic device converts the energy of ionising radiation directly into power using a semiconductor junction. Depending on the type of radiation targeted, the devices can be called alpha voltaic, beta voltaic or gamma voltaic cells.

Alphavoltaic cells convert alpha particles from an alpha-emitting radioisotope source into electrical energy.

Betavoltaic devices convert beta particles from a beta-emitting radioisotope source into electrical energy. Tritium is commonly used as a source of beta decay. Betavoltaic devices are well-suited for low power electrical applications wherein a long life of the energy source is required, such as military, space applications or in implantable medical devices.

Gammavoltaic devices convert energetic gamma particles or high energy photons from gamma-emitting radioisotope sources into electrical energy.

The radioisotopes generated using the present invention can also be used in radiophotovoltaic devices or optoelectric conversion wherein the energy emitted from the radioisotopes is first converted into light using a radio luminescent material, such as a scintillator or phosphor, and the light is further converted into electrical energy using a photovoltaic cell. Depending on the type of radioisotope particle targeted, the conversion can be alphaphotovoltaic, betaphotovoltaic or gammaphotovoltaic.

Several radioisotopes generated using the present invention can also be used in pacemakers and many other implantable medical devices having long half-life of many decades, wherein their long half-life allows for an advantage over pacemakers, and other currently used implantable medical devices which need to be replaced often, due to their short half-life.

The radioisotopes generated using the present invention can also be used to power radioisotope rockets or radioisotope thermal rockets which use the heat generated by the decay of radioactive elements to heat a working fluid, which is further exhausted through the nozzle of the rocket to produce thrust. Radioisotopes can alternatively be used in a radioisotope electric rocket wherein the energy from radioactive decay is used to generate the electrical energy used to power an electric propulsion system.

Radioisotopes can also be used in Radioisotope heater units or RHU which are small devices that provide heat through radioactive decay.

Radioisotopes produced using the present invention can also be used for calculation of terrestrial age of meteorites and comets, to determine surface exposure ages and erosion rates, to date glaciers, sediments in research on paleoenvironmental change, determining ground water infiltration rates, estimate marine sedimentation of biogenic silica (diatoms and seashells) and as radiotracer for the measurement of silica production in aquatic environments

Several other applications include, but are not limited to, tracer for phosphorylated molecules (for instance, in elucidating metabolic pathways) and radioactively label DNA, especially in the medical, molecular biology and life sciences field; Cancer therapy and diagnosis for ovarian cancer, prostate cancer, breast cancer, neuroendocrine tumours (NETs), neuroblastoma, glioma, lymphoma, bladder cancers; PET and SPECT imaging, for instance for assessing myocardial and cerebral perfusion, bone metastases, neuroendocrine tumours, prostate cancer, renal perfusion, Wilson's disease, insulinoma pancreatic islets, breast cancer; for predicting the efficacy of radioimmunotherapy and antibody therapies, imaging target expression, detecting target-expressing tumours, and the monitoring of anti-cancer chemotherapies; Bone pain palliation, Used for synovectomy treatment of arthritis, diagnosis of coronary artery disease and parathyroid hyperactivity; X-ray source for scientific analysis, for example X-ray diffraction, ideal for portable X-ray instruments, for example X-ray fluorescence spectrometer; Source of Auger electrons with use in gas chromatography; used in Schilling test; Radiation treatment of foods for sterilisation (cold pasteurisation); Industrial radiography (for example, weld integrity radiographs); Density measurements (for example, concrete density measurements; Plaque therapy, for instance for ocular melanomas; Useful as a heat source for sensitive electrical components; Used in static eliminators; Used in Offshore oil rigs and at power generation plants during outages to reduce non-occupational worker exposure; Used for tracing element migration in soil and plants; Used as an ionisation source in electron-capture detectors for analysing pesticides in water environments; During preparations for long-term interplanetary missions to stimulate space conditions on Earth; as a night lighting device or a self-sustaining light source; as a Multiwire gamma camera (MWGC) which can be utilised as a nuclear medicine imaging device; used as a gamma ray source in industrial radiography to locate flaws in metal components; in Targeted alpha therapy (AML, Lymphoma, prostate cancer, melanoma, glioblastoma, bladder cancer, neuroendocrine tumours, leukaemia)/Ovarian cancer, prostate cancer, pancreatic cancer, neuroendocrine tumours)/resistant metastatic prostate cancer, ovarian carcinoma)/Glioblastoma, ovarian cancer, blood-borne cancers); Used as the energy source in radioluminescent lights for watches, gun sights, numerous instruments and tools.

Other applications of medical radioisotopes:
Neurological applications—Stroke, Alzheimer's disease, demonstrate changes in AIDS, Dementia, evaluate patients for carotid surgery, localise seizure foci, evaluate post-concussion syndrome, diagnose multi-infarct dementia
Orthopaedic applications—Identify occult bone trauma, diagnose osteomyelitis, evaluate arthritic changes and extent, localise sites for tumour biopsy, measure extent of certain tumours and identify bone infarcts in sickle cell disease
Cardiac applications—coronary artery disease, measure effectiveness of bypass surgery, measure effectiveness of therapy for heart failure, detect heart transplant rejection, select patients for bypass or angioplasty, identify surgical patients at high risk for heart attacks, identify right heart failure, measure chemotherapy cardiac toxicity, evaluate valvular heart disease, identify shunts, and quantify them, diagnose and localise acute heart attacks before enzyme changes
Pulmonary applications—Diagnose pulmonary emboli, detect pulmonary complications of AIDS, quantify lung ventilation and perfusion, detect lung transplant rejection, and detect inhalation injury in burn patients
Renal applications—Detect urinary tract obstruction, diagnose renovascular hypertension, measure differential renal function, detect renal transplant rejection, detect pyelonephritis, detect renal scars
Oncology applications—Tumour localisation, tumour staging, identify metastatic sites, judge response to therapy, relieve bone pain caused by cancer
Other applications—detect occult infections, diagnose and treat blood cell disorders, diagnose and treat hyperthyroidism (Grave's disease), detect acute cholecystitis, chronic biliary tract dysfunction, detect acute gastrointestinal bleeding and detect testicular torsion

With the growing complexity of positron emission tomography (PET)/single photon emission computed tomography (SPECT) imaging and the developments in systemic radionuclide therapy there is a growing need for radioisotope preparations with higher radionuclidic and radiochemical purity than previously possible. The specific activity of the radiotracer is particularly essential for the new applications.

An object of the present invention is, therefore, to provide a method for the large-scale production of high-purity radionuclides, especially of non-carrier added or carrier free radioisotopes.

The invention relates to a general method for industrial scale production of radioisotope preparations for life science research, medical application, Energy application and industry. It allows for the mass manufacturing of a variety of rare isotopes that were previously unavailable on the market but are now in high demand.

Separation of the isotope of interest from the resultant target material, which was produced by transmutation of target element/s (target element can be any one or more elements of the periodic table from Hydrogen to Uranium and Transuranic elements) using mercury-based compound as per prior art WO2016 181204 A1 or any prior art wherein fabricated mercury-based compound is paramagnetic and is present in an excited state “metastable”, can be achieved using high temperature desorption from the target surface in an inert atmosphere (e.g. Ar, He . . . )—or under vacuum.

If the target element is less volatile than the target material, then separation of the isotope of interest from the resultant target material, which was produced by transmutation of target element/s (target element can be any one or more elements of the periodic table from Hydrogen to Uranium and Transuranic elements) using mercury-based compound as per prior art WO2016 181204 A1 or any prior art wherein fabricated mercury-based compound is paramagnetic and is present in an excited state “metastable”, can be achieved by removing the target material using sublimation in an inert atmosphere or under vacuum.

Separation of the isotope of interest from the resultant target material, which was produced by transmutation of target element/s (target element can be any one or more elements of the periodic table from Hydrogen to Uranium and Transuranic elements) using mercury-based compound as per prior art WO2016 181204 A1 or any prior art wherein fabricated mercury-based compound is paramagnetic and is present in an excited state “metastable”, can be achieved by adsorption on appropriate substrates present in the flow of the resultant target material and coolant medium

Desorption of the radionuclides of interest from the resultant target material, which was produced by transmutation of target element/s (target element can be any one or more elements of the periodic table from Hydrogen to Uranium and Transuranic elements) using mercury-based compound as per prior art WO2016 181204 A1 or any prior art wherein fabricated mercury-based compound is paramagnetic and is present in an excited state “metastable”, can be achieved by chemical evaporation technique, i.e., the addition of chemical reactive gases that form in-situ more Volatile compounds of the radionuclides of interest.

At present the production of alpha-emitting radionuclides takes place in nuclear reactor-cyclotron and generator system, but it can produce limited quantity of alpha-emitting radionuclides and is very expensive. Whereas present invention and its subject matter of claims will produce radioisotopes and alpha-emitting radionuclides for wider community at much lower cost

In 2018, the cancer burden globally increased to approximately 18.1 million new cases and 9.6 million deaths. Worldwide the total number of people who are alive within 5 years of a cancer diagnosis, called 5 year prevalence, is estimated to be 43.8 million.

Currently, only 1.7 Ci or 63 Gbq of ²²⁵Ac can be produced globally every year using the existing ²²⁹Th sources, which is not enough to cover all the demand for ²²⁵Ac.

The limited amount of 225Ac produced annually is sufficient for pre-clinical or clinical trials, but is not enough for commercial product development, including licencing and approval.

According to recent estimates, the minimum required annual production of 225Ac is ˜100-200 Ci/year, assuming 1 mCi per patient and 100,000-200,000 patients per year.

The present invention will be able to produce large quantity of alpha-emitting radionuclides such as 225Ac to meet global demand, curing millions of people suffering from cancer.

Cancer is the second biggest cause of death worldwide, accounting for 9.6 million fatalities, or one in every six deaths, in 2018. Prostate, stomach, colorectal, liver and lung cancer are the most common kinds of cancer in males while colorectal, cervical, lung, thyroid and breast cancer are the most common among females.

Targeted alpha therapy will play an important role in the treatment of disseminated, chemo resistant and radioresistant metastatic disease, against which there are no efficacious treatment options.

Nuclear reactor-cyclotron and generator system can produce alpha-emitting radionuclides in a very limited quantity and is expensive. Currently, only a small number of radioisotopes are applicable to targeted alpha therapy. However, to tackle the different cancer diseases, several alpha-emitting radionuclides should be further studied and made available to a broader community.

However, large amounts of alpha-emitting radionuclides are needed to attain an effective treatment due to the short half-life and cost of its use in cancer therapy is a major concern.

To make alpha-emitting radioisotopes more widely available, researchers are working to develop more efficient and simple production methods.

The present invention is capable to make available alpha-emitting radionuclides to wider community for betterment of our society in a cost-effective way.

Alpha-emitting radionuclides for therapeutic radiopharmaceuticals plays a significant role curing cancer.

Alpha-emitters have definite competitive advantages over other therapeutic radionuclides:
Reduced toxicity due to short range
Greater efficacy due to high LET
Alpha particle therapy is less sensitive to hypoxia compared to beta therapy and photon irradiation due to direct DNA lysis
The RBE of alpha-therapy, along with the multiple processes for cell killing and difficulty in repairing DNA damage, all lead to a reduced incidence of radio-resistance.

Apart from analysing nuclear waste or contamination, automated radiochemical separation also allows for the isolation and purification of radionuclides for medical purposes, a process known as medical isotope “generation”. Short-lived radioisotopes, for example, can be used in cancer treatment and medical imaging. The radioactive decay of longer-lived parent isotopes produces these short-lived daughter isotopes.

Using Prior art PCT Publication number WO 2016181204 A1 for fabrication of mercury-based compound, wherein fabricated mercury-based compound is paramagnetic and is present in the excited state “metastable”:

75 ml of Concentrated HCl was placed in a beaker and 25 ml of concentrated HNO₃ was added to it to form aqua regia. 50 g of pure liquid mercury metal was gradually added to the formed aqua regia in order to start the reaction. The reaction started and was kept in the beaker for one hour at room temperature. The beaker containing the reaction mixture was placed on a hot plate and heated to a temperature ranging from 90° C. to 135° C. for 2.5 hours. This resulted in 65.7 g of mercury-based compound in dry powder form, wherein fabricated mercury-based compound is paramagnetic and is present in the excited state “metastable”

The Electron Spin Resonance (ESR/EPR) analysis was performed on pure liquid mercury metal (99.9%) at The Indian Institute of Technology (IIT), Bombay, India in the month of June 2021. ESR analysis spectrum clearly shows that there is no peak present and thus the pure liquid mercury metal (99.9%) is diamagnetic.

Electron Spin Resonance (ESR) analysis was performed at Indian Institute of Technology (IIT) Mumbai, India on fabricated mercury-based compound to know the paramagnetic properties of the mercury-based compound. The ESR results clearly show distinct peaks which proves that the fabricated mercury-based compound is paramagnetic.

Fabrication of paramagnetic and excited state “metastable” mercury-based compound and using it as a source of energy for transmutation of elements (based on prior art PCT Publication number WO 2016181204 A1). Paramagnetic and excited state “metastable” mercury-based compound is reacted with the nucleus of target element/s (target element can be any one or more elements of the periodic table from hydrogen to uranium and trans uranic elements), and target element/s are transmuted into many new elements including low mass, high mass, high density, rare earth and super heavy elements, achieving very high transmutation rates, which is many times of all other technologies currently being used for transmutation of elements, e.g. Accelerated Driven System (ADS), Particle Accelerator etc.

### EXAMPLE 1

High purity (99.9%) Cadmium (Cd) was used as a target element. The 50 g of target element Cadmium was put into a graphite crucible of a melting furnace and heated to the molten state above its melting point. The temperature is taken up to 450° C. Once the target elements cadmium was heated until present in the molten state, 50 mg of the paramagnetic and excited state mercury-based compound (as per prior art PCT Publication number WO 2016181204 A1) was added to 50 g of the molten cadmium and the reaction was allowed to take place for a certain period of time while the mixture was stirred. Following this, resultant target material in molten state was poured off in a mould and allowed to cool down to room temperature so as to solidify the resultant target material. As per analysis results of FEG SEM EDS performed at Indian Institute of Technology IIT MUMBAI INDIA in the month of October 2021, resultant target material contains the following elements including radioisotopes of interest outlined in Table 1.

### EXAMPLE 2

High purity (99.9%) Tin (Sn) was used as a target element. The 50 g of target element tin was put into a graphite crucible of a melting furnace and heated to the molten state above its melting point, i.e. to 360° C. Once the tin was heated until present in the molten state, 50 mg of the paramagnetic and excited state mercury-based compound (as per prior art PCT Publication number WO 2016181204 A1) was added to 50 g of the molten tin and the reaction was allowed to take place for a certain period of time while the mixture was stirred. Following this, resultant target material in molten state was poured off in a mould and allowed to cool down to room temperature so as to solidify the resultant target material. As per analysis results of FEG SEM EDS performed Indian Institute of Technology IIT MUMBAI INDIA in the month of October 2021, resultant target material contains the following elements including radioisotopes of interest outlined in Table 1.

### EXAMPLE 3

High purity (99.9%) bismuth (Bi) was used as a target element. The 50 g of target element bismuth was put into a graphite crucible of a melting furnace and heated to the molten state above its melting point, i.e. to 370° C. Once the bismuth was heated until present in the molten state, 50 mg of the paramagnetic and excited state mercury-based compound (as per prior art PCT publication number WO 2016181204 A1) was added to 50 g of the molten bismuth and the reaction was allowed to take place for a certain period of time while the mixture was stirred. Following this, resultant target material in molten state was poured off in a mould and allowed to cool down to room temperature so as to solidify the resultant target material. As per analysis results of FEG SEM EDS performed at Indian Institute of Technology IIT MUMBAI INDIA in the month of October 2021, resultant target material contains the following elements including radioisotopes of interest outlined in Table 1.

Table 1 below shows that the resultant target materials Examples 1 to 3 produced using the methods described above contain radioisotopes.

Example

| Resultant Target Material | 1 | 2 | 3 |
|---|---|---|---|
| Element | C | C | C |
| Element | O | O | O |
| Element | Si | P | F |
| Element | P | As | Mo |
| Element | Ar | Mo | Tc |
| Element | Pd | In | Yb |
| Element | Cd | Sn | Ta |
| Element | Er | Te | W |
| Element | Yb | I | Hg |
| Element | Ra | Xe | Bi |
| Element | Ac | La | Rn |
| Element | | Er | Fr |
| Element | | Yb | Ra |
| Element | | Pb | Th |

Table 1 shows the compounds revealed during SEM-EDS measurements of the respective resultant target materials Examples 1 to 3.

Table 2 of infrared spectrums of the resultant target materials (Examples 1 to 3) using Fourier-Transform Infrared Spectroscopy (FTIR). The peaks seen in the spectra indicate the presence of functional group complexes/polymers (alkanes, alkenes, amines, esters, alcohol, aromatics, ketones and so on) along with radioisotopes present in the resultant target material. The peaks seen in the spectra are listed in Table 2.

| | Example | | |
|---|---|---|---|
| Resultant Target Material | 1 | 2 | 3 |
| Peak | 439.55 | 567.05 | 544.20 |
| Peak | 857.38 | 1040.57 | 601.26 |
| Peak | 1045.49 | 1384.20 | 1042.41 |
| Peak | 1400.38 | 2924.43 | 1093.83 |
| Peak | 3497.11 | 3443.08 | 1384.70 |
| Peak | 3601.34 | 3563.84 | 3441.69 |

Table 2 shows some of the most prominent peaks (wavenumber cm-1) present in the FITR spectrum of the resultant target material Example 1 to 3. The six peaks shown are not always the most prominent peaks but are arbitrarily selected to show the variety of peaks present in the spectrum.

### BRIEF DESCRIPTION OF THE DRAWINGS

FIG. 1:

The Electron Spin Resonance (ESR/EPR) analysis was performed on pure liquid mercury metal (99.99%) at The Indian Institute of Technology (IIT), Bombay, India in the month of June 2021. The analysis spectrum clearly shows that there is no peak present and thus the pure liquid mercury metal (99.99%) is diamagnetic.

FIG. 2:

Pure liquid mercury metal (99.99%) was used to fabricate the mercury-based compound as per the prior art PCT Publication number WO 2016 181204 A1. The fabricated mercury-based compound was analysed using Electron Spin Resonance (ESR/EPR) at The Indian Institute of Technology (IIT), Bombay, India in the month of June 2021. The analysis result clearly shows that there is a clear, distinct peak present which proves that the fabricated mercury-based compound is paramagnetic.

FIG. 3:

FIG. 3 shows a Fourier Transformed Infrared Spectrum (FTIR) of the resultant target material after transmutation of pure target element Cadmium (99.9%) at the Indian Institute of Technology (IIT), Mumbai, India in the month of October 2021.

The peaks seen in the spectrum hint at the respective presence of amines, alcohols, bromoalkanes, chloroalkanes and esters. The peaks seen in the spectra indicate the presence of functional group complexes/polymers (alkanes, alkenes, amines, esters, alcohol, aromatics, ketones and so on) along with radioisotopes present in the resultant target material.

FIG. 4.

FIG. 4 shows a Fourier Transformed Infrared Spectrum (FTIR) of the resultant target material after transmutation of pure target element Tin (99.9%) at the Indian Institute of Technology (IIT), Mumbai, India in the month of October 2021.

The peaks seen in the spectrum hint at the respective presence of amines, alcohols, bromoalkanes, chloroalkanes and esters. The peaks seen in the spectra indicate the presence of functional group complexes/polymers (alkanes, alkenes, amines, esters, alcohol, aromatics, ketones and so on) along with radioisotopes present in the resultant target material.

FIG. 5:

FIG. 5 shows a Fourier Transformed Infrared Spectrum (FTIR) of the resultant target material after transmutation of pure target element Mercury (99.9%) at the Indian Institute of Technology (IIT), Mumbai, India in the month of October 2021.

The peaks seen in the spectrum hint at the respective presence of amines, alcohols, bromoalkanes, chloroalkanes and esters. The peaks seen in the spectra indicate the presence of functional group complexes/polymers (alkanes, alkenes, amines, esters, alcohol, aromatics, ketones and so on) along with radioisotopes present in the resultant target material.

FIG. 6:

FIG. 6 shows a Fourier Transformed Infrared Spectrum (FTIR) of the resultant target material after transmutation of pure target element Bismuth (99.9%) at the Indian Institute of Technology (IIT), Mumbai, India in the month of October 2021.

The peaks seen in the spectrum hint at the respective presence of amines, alcohols, bromoalkanes, chloroalkanes and esters. The peaks seen in the spectra indicate the presence of functional group complexes/polymers (alkanes, alkenes, amines, esters, alcohol, aromatics, ketones and so on) along with radioisotopes present in the resultant target material.

FIG. 7:

FIG. 7 of SEM/EDS analysis performed at the Indian Institute of Technology (IIT), Mumbai, India in the month of October 2021 of resultant target material after transmutation of pure target element Cadmium (99.9%) with fabricated paramagnetic and excited state mercury-based compound (as per prior art PCT Publication number WO 2016181204 A1). The SEM/EDS analysis results clearly show that there are many new elements present, including radioisotopes such as Er, Yb, Ra, Ac.

| Element | Weight % | Atomic % |
|---|---|---|
| C K | 8.67 | 23.77 |
| O K | 27.37 | 56.37 |
| Si K | 0.09 | 0.11 |
| P K | 1.39 | 1.47 |
| Ar K | 0.52 | 0.43 |
| Pd L | 0.51 | 0.16 |
| Cd L | 58.67 | 17.20 |
| Er M | 0.82 | 0.16 |
| Yb M | 1.05 | 0.20 |
| Ra M | 0.45 | 0.07 |
| Ac M | 0.46 | 0.07 |
| Totals | 100.00 | |

FIG. 8

FIG. 8 of SEM/EDS analysis performed at the Indian Institute of Technology (IIT), Mumbai, India in the month of October 2021 of resultant target material after transmutation of pure target element Tin (99.9%) with fabricated paramagnetic and excited state mercury-based compound (as per prior art PCT Publication number WO 2016181204 A1). The SEM/EDS analysis results clearly show that there are many new elements present, including radioisotopes such as As, Mo, In, Te, I, Xe, La, Er, Yb, Pb

| Element | Weight % | Atomic % |
|---|---|---|
| C K | 0.47 | 2.78 |
| O K | 8.98 | 40.05 |
| P K | 1.92 | 4.41 |
| As L | 0.30 | 0.28 |
| Mo L | 0.40 | 0.30 |
| In L | 0.37 | 0.23 |
| Sn L | 80.17 | 48.21 |
| Te L | 2.69 | 1.50 |
| I L | 1.14 | 0.64 |
| Xe L | 0.72 | 0.39 |
| La L | 0.28 | 0.15 |
| Er M | 0.92 | 0.39 |
| Yb M | 1.29 | 0.53 |
| Pb M | 0.37 | 0.13 |
| Totals | 100.00 | |

FIG. 9:

FIG. 9 of SEM/EDS analysis performed at the Indian Institute of Technology (IIT), Mumbai, India in the month of October 2021 of resultant target material after transmutation of pure target element Bismuth (99.9%) with fabricated paramagnetic and excited state mercury-based compound (as per prior art PCT Publication number WO 2016181204 A1). The SEM/EDS analysis results clearly show that there are many new elements present including radioisotopes such as Mo, Tc, Yb, Ta, W, Bi, Rn, Fr, Ra, Th.

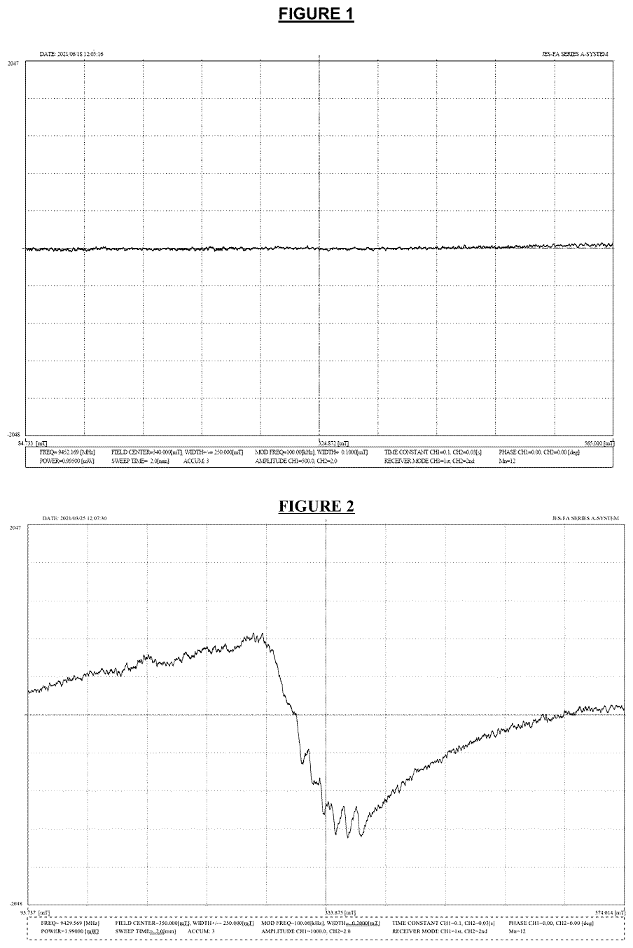

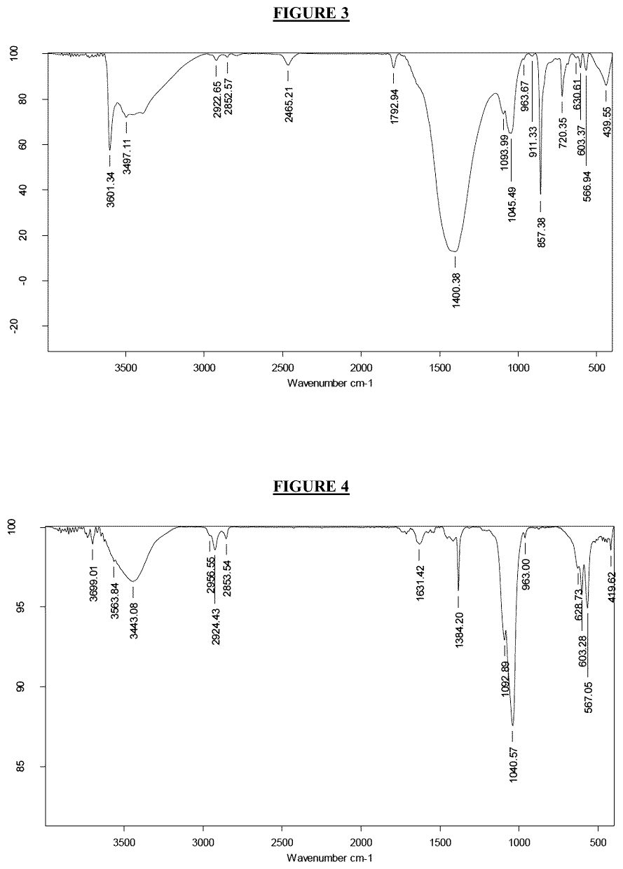

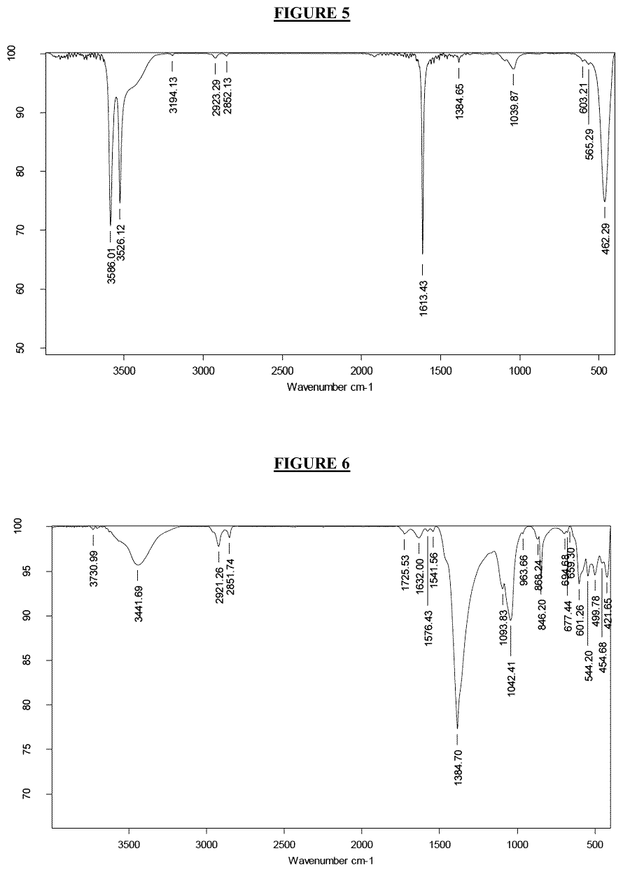

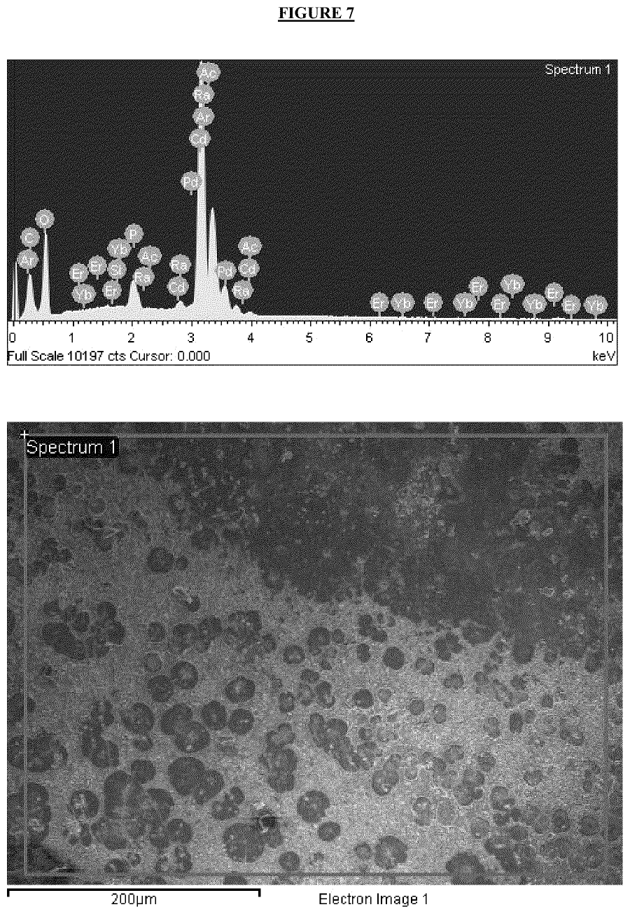

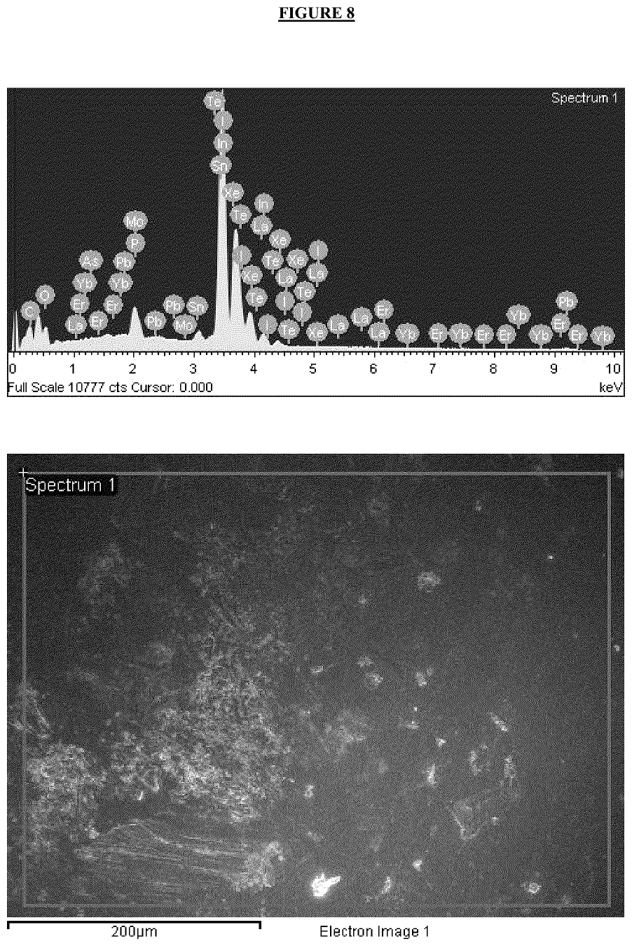

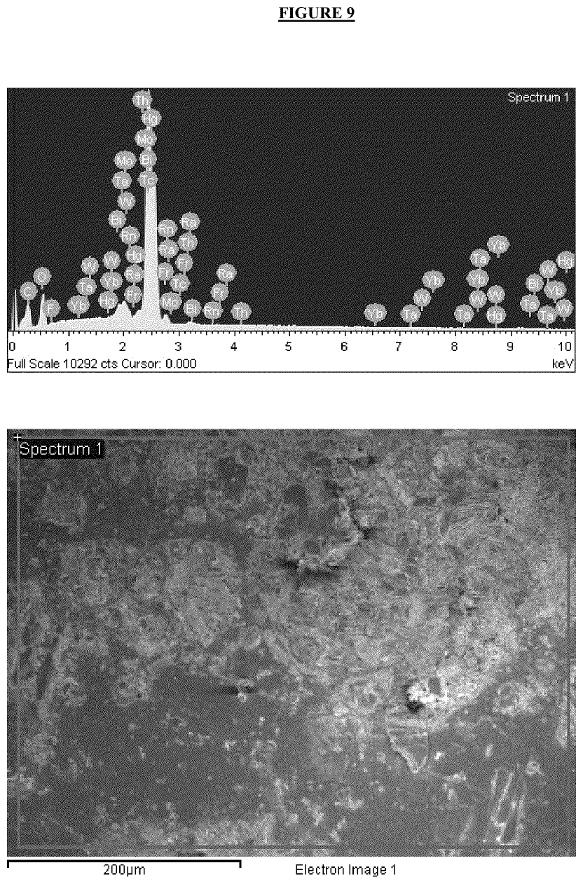

| Element | Weight % | Atomic % |
|---|---|---|
| C K | 5.84 | 30.24 |
| O K | 9.89 | 38.44 |
| F K | 1.03 | 3.36 |
| Mo L | 2.23 | 1.45 |
| Tc L | 7.12 | 4.47 |
| Yb M | 0.47 | 0.17 |
| Ta M | 0.33 | 0.11 |
| W M | 0.66 | 0.22 |
| Hg M | 3.07 | 0.95 |
| Bi M | 66.23\| | 19.71 |
| Rn M | 0.75 | 0.21 |
| Fr M | 1.29 | 0.36 |
| Ra M | 0.73 | 0.20 |
| Th M | 0.38 | 0.10 |
| Totals | 100.00 | |

### DESCRIPTION OF EXEMPLARY EMBODIMENTS

According to the method of the present invention production, separation and purification of radionuclides from the resultant target material after target element is transmuted into many new elements, wherein paramagnetic and excited state mercury-based compound is used and reacted with target elements (one or more elements of the periodic table from Hydrogen to Uranium and Transuranic elements) and their subsequent concentration and purification into monoisotopic samples is achieved by application of a number of separation and purification methods.

Target elements is present in molten condition, gaseous form, liquid form, solid form, ion form, salt form or in combination thereof but not limited to it.

Target elements is put into a crucible of a melting furnace and mixed with paramagnetic and excited state mercury-based compound (Based on prior art PCT Publication number WO 2016181204 A1) or any other prior art wherein fabricated mercury-based compound is paramagnetic and is present in the metastable excited state.

An excited nucleus normally emits a gamma ray in a short amount of time. Certain excited nuclei, on the other hand, are “metastable,” which means they can delay gamma ray emission. The delay could last a fraction of a second or it could last minutes, hours, years, or even longer. The delay arises when the nucleus' spin prevents gamma decay. Moreover, when an orbiting electron absorbs a gamma ray and is ejected from orbit, another special effect called the photoelectric effect occurs.

Fabrication of paramagnetic and excited state “metastable” mercury-based compound and using it as a source of energy for transmutation of elements (based on prior art PCT Publication number WO 2016181204 A1). Paramagnetic and excited state “metastable” mercury-based compound is reacted with the nucleus of target element/s (target element can be any one or more elements of the periodic table from hydrogen to uranium and trans uranic elements), and target element/s are transmuted into many new elements including low mass, high mass, high density, rare earth and super heavy elements, achieving very high transmutation rates, which is many times of all other technologies currently being used for transmutation of elements, e.g. Accelerated Driven System (ADS), Particle Accelerator etc.

Temperature is taken above melting point/critical point of target elements and paramagnetic and excited state mercury-based compound reacts with nucleus of target elements. During this process, the target element is transmuted into many new elements including low mass elements/isotopes, high mass elements/isotopes, high density elements/isotopes, rare earth elements/isotopes and super heavy elements/isotopes.

Furnace is turned off and resultant target material is cooled down.

The isotope of interest or chemical compound will be transported to the next purification steps by a gas flow or molecular flow at high temperatures.

Conditioning for radioisotopes by addition of suitable chemicals that either allow pyrochemical reduction to the elementary state or oxidation/molecule formation on the other hand and controlling the mass separation process i.e. mass marking.

The isotope of interest can be transported to the surface of the target material using high temperature diffusion

The separation of the isotope of interest from the resultant target material by high temperature desorption from the target surface under vacuum or in inert atmosphere, and/or

The separation of the isotope of interest from the resultant target material by removing the target material by high temperature sublimation under vacuum or in inert atmosphere, and/or

The separation of the isotope of interest from the resultant target material by adsorption on suitable substrates located in the flow of a liquid metal target and coolant medium, and/or

The desorption of the isotope of interest from the bulk target material by means of chemical evaporation.

The obtained isotopes have several in vivo and in vitro applications in medicine and research for the diagnosis and therapy of diseases, including, biodistribution studies, PET and SPECT imaging, RIT, TAT, gamma spectroscopy, Auger-therapy, radioembolization and so on.

Preferably, the separation of the isotopes from the resultant target material is carried out by bringing the target to high temperature, e.g. solid targets to 60-95% of their melting point, under vacuum, e.g. in the order of 10⁻⁵ mbar or better, or suitable gas atmosphere. A noble gas (He, Ne, Ar, etc.) that does not react with the heated target is the chosen appropriate gas environment. Occasionally, reactive gases such as O₂, CF₄, etc. are supplied in a quantity that is not harmful to the target but high enough to promote the release of the desired isotopes, e.g., at a partial pressure of 10⁻⁴ mbar.

Evaporation under vacuum or inert gas removes the target material, leaving the less volatile elements in the residue. Depending on the element, different approaches can be used to recover the desired nuclei from the residue.

Mass separation can be carried out using the magnetic sector field or an array or mass-selective devices including the radio-frequency quadrupole, Wein-filter and so on, but not limited to it.

There is also a possibility of isobars, atoms of different elements with different mass numbers, or isotopes of the same element being produced in the same system. In this instance, it is essential to have a mass-selective device which would allow for the simultaneous collection of several masses.

Irrespective of how the desired radioisotope fraction is obtained, it can directly be employed for the labelling procedure of bio-conjugates or injected directly into a chromatographic system or other applicable methods for further purification.

If the desired radioisotopes need to be obtained in a gaseous form, a straightforward separation can be achieved using thermal release from a refractory matrix.

Mercury is a diatomic metallic cation, made up of two mercury (I) ions, bonded to each other. Since the actual individual mercury ion in the pair has a +1 charge, then that is the fundamental particle. As opposed to the mercury (II) ion, which is an individual mercury ion with a +2 charge. Because Hg+1 is too unstable on its own and hence as soon as it is formed, fuses with another Hg+1 ion to form Hg+2 ion and will henceforth remain so.

Several traditional radiochromatographical and radiochemical processes including extraction, precipitation, electrochemical separation, anion exchange chromatography, cation exchange chromatography, thermo chromatography and gas chromatography, can be used to separate the desired radioisotope from several isobars and pseudobars, which result from molecular sidebands like fluorides or oxides that appear at the same mass settings, and from impurities generated.

Ligands used in the chemical separation process end up in the product fraction and must be removed before proceeding with additional labelling activities. In many circumstances, evaporation is the best option.

The desired radioisotope products obtained following separation and purification are carrier-free or non-carried added and isotopically pure.

The chain of production, separation and purification can be operated as described above. However, the number of stages can be adjusted to meet the purity requirements of the respective application.

Fabrication of paramagnetic and excited state “metastable” mercury-based compound and using it as a source of energy for transmutation of elements (based on prior art PCT Publication number WO 2016181204 A1). Paramagnetic and excited state “metastable” mercury-based compound is reacted with the nucleus of target element/s (target element can be any one or more elements of the periodic table from hydrogen to uranium and trans uranic elements), and target element/s are transmuted into many new elements including low mass, high mass, high density, rare earth and super heavy elements, achieving very high transmutation rates, which is many times of all other technologies currently being used for transmutation of elements.

The present invention relates to a process for the production, separation and purification of alpha-emitting radionuclides and more specifically, this invention related to a process, apparatus and system for separation and purification of alpha-emitting radionuclides, beta-emitting radionuclides, gamma/X-ray emitting radionuclides from transmuted resultant target material containing low mass, high mass, high density, rare earth, lanthanides and actinides radionuclides produced by a process, wherein target elements (any one or more elements of the periodic table, e.g. hydrogen to uranium and transuranic elements) are reacted with paramagnetic and excited state of mercury based compound for transmutation of elements and production of alpha-emitting radionuclides, beta-emitting radionuclides, gamma/X-ray emitting radionuclides.

The present disclosure relates generally to the field of chemistry, radiochemistry, Electrochemistry, nuclear physics and nuclear chemistry, in particular, to process, apparatus and system for the separation and purification of alpha, beta, gamma/X ray emitting radioisotopes for nuclear medicine to cure life threatening diseases like cancer, heart attack and brain disorder, industrial applications, Alpha voltaic cells, beta voltaic cells, radioisotope based thermoelectric generators, radioisotopes based batteries for air, sea and road transportation system and for agriculture uses.

The present invention relates to a process for the separation and purification of alpha-emitting radionuclides and more specifically, this invention related to a process, apparatus and system for separation and purification of alpha-emitting radionuclides, beta-emitting radionuclides, gamma/X-ray emitting radionuclides from transmuted resultant target material containing low mass, high mass, high density, rare earth, lanthanides and actinides radionuclides produced by a process, wherein target elements (any one or more elements of the periodic table, e.g. hydrogen to uranium and transuranic elements) are reacted with paramagnetic and excited state of mercury based compound having internal resting energy in the terms of hundreds of terajoule for transmutation of elements and production of alpha-emitting radionuclides, beta-emitting radionuclides, gamma/X-ray emitting radionuclides.

It is an embodiment, the present disclosure relates to a process, apparatus and system for the separation and purification of alpha, beta, gamma/X-ray emitting radioisotopes for nuclear medicine to cure life threatening diseases like cancer, heart attack and brain disorder, industrial applications, Alpha voltaic cells, beta voltaic cells, radioisotope based thermoelectric generators, radioisotopes-based batteries for air, sea and road transportation system and for medical, industrial and agriculture uses.

It is an embodiment, the present disclosure relates to a process, apparatus and system for separation and purification of low mass, high mass, high density, rare earth, lanthanides and actinide radioisotpes from resultant target material obtained by transmutation of hydrogen to uranium and transuranic elements by paramagnetic and excited state mercury-based compound.

It is another embodiment, the present disclosure relates to a process, apparatus and system for separation and purification of radioisotopes from resultant target material obtained by transmutation of target elements hydrogen to uranium and transuranic elements/isotopes, (one or more elements of periodic table, its isotopes, alloys, salts, Oxides and so on).

It is another embodiment, the present disclosure relates to a process, apparatus and system for separation and purification of radioisotopes from resultant target material present in molten state, solid state, gaseous state and liquid state.

It is another embodiment, the present disclosure relates to a process, apparatus and system for separation and purification of alpha-emitting radioisotopes from resultant target material present obtained by transmutation of target elements from hydrogen to uranium and transuranic elements/isotopes using paramagnetic and excited state mercury based compound having internal resting energy in terms of hundreds of terajoule and capable to transmute elements, (one or more elements of periodic table, its isotopes, alloys, salts, Oxides and so on, which are present in molten state, solid state, gaseous state and liquid state).

It is another embodiment, the present disclosure relates to a process, apparatus and system for separation and purification of beta-emitting radioisotopes from resultant target material present obtained by transmutation of target elements from hydrogen to uranium and transuranic elements/isotopes using paramagnetic and excited state mercury based compound having internal resting energy in terms of hundreds of terajoule and capable to transmute elements, (one or more elements of periodic table, its isotopes, alloys, salts, Oxides and so on, which are present in molten state, solid state, gaseous state and liquid state).

It is another embodiment, the present disclosure relates to a process, apparatus and system for separation and purification of Gamma-emitting/X Ray-emitting radioisotopes from resultant target material obtained by transmutation of target elements from hydrogen to uranium and transuranic elements/isotopes using paramagnetic and excited state mercury based compound having internal resting energy in terms of hundreds of terajoule and capable to transmute elements, (one or more elements of periodic table, its isotopes, alloys, salts, Oxides and so on, which are present in molten state, solid state, gaseous state and liquid state).

It is another embodiment, the present disclosure relates to a Radioisotopes Generator System, that separates and purifies alpha-emitting radioisotopes and other isotopes from resultant target material containing radioisotopes by conversion of one chemical element into another element/s, using any one element or more elements of periodic table.

It is an another embodiment that the process, apparatus and system referred to herein as a Radioisotopes Generator System.

It is another embodiment, the present disclosure relates to a Radioisotopes Generator System, that separates and purifies alpha-emitting radioisotopes with major advantages of the transmutation process using paramagnetic and excited state mercury based compound having large internal resting energy for transmutation of elements for production of short-lived alpha-emitting radioisotopes having high specific activity.

It is another embodiment, the present disclosure relates to a Radioisotopes Generator System, that separates and purifies alpha-emitting radioisotopes for nuclear medicine to cure life threatening diseases like cancer, heart attack and brain disorder.

It is another embodiment, the present disclosure relates to a Radioisotopes Generator System, that separates and purifies alpha-emitting radioisotopes having a relatively short half-life so that after serving its desired purpose it will decay and not cause excess damage to the surrounding organs and tissues.

It is another embodiment, the present disclosure relates to a Radioisotopes Generator System, that separates and purifies the lanthanide and actinide elements which have suitable characteristics for use as medical radionuclides.

For diagnostic purposes the radioisotope must have an image-able gamma ray. For therapeutic applications the radionuclide should have beta or alpha emissions with energy levels suitable for delivering a therapeutic dose to the target tissue.

It is another embodiment, the present disclosure relates to a Radioisotopes Generator System, that separates and purifies the lanthanide and actinide radioisotopes in solution.

It is another embodiment, the present disclosure relates to a Radioisotopes Generator System, that separates and purifies the lanthanide and actinide elements which predominantly exist in the +3 valence state and all exhibit similar chemical characteristics. This enables the application of the same synthesis route and procedure for the synthesis of different lanthanide and actinide compounds.

It is another embodiment, the present disclosure relates to a Radioisotopes Generator System, that separates and purifies radioisotopes for primary application in the medical field, where they are used for diagnostic purposes such as medical imaging and therapeutic applications such as cancer treatment.

It is another embodiment, the present disclosure relates to a Radioisotopes Generator System, that separates and purifies radionuclides with high specific activity so a minimal concentration can be administered with maximum effect, to prevent chemical toxicity complications.

It is another embodiment, the present disclosure relates to a Radioisotopes Generator System, for separation and purification of alpha-emitting radioisotopes such as Th-227, Ac-225, Ra-224, Ra-223, Bi-213, Bi-212, Pb-211, At-211 the method having the steps of dissolving resultant target material obtained by transmuation of target elements from hydrogen to uranium and transuranic elements/isotopes by using a paramagnetic and excited state mercury based compound having internal resting energy in terms of hundreds of terajoule and capable to transmute elements, (one or more elements of periodic table, its isotopes, alloys, salts, Oxides and so on. which are present in molten state, solid state, gaseous state and liquid state).

It is another embodiment, the present disclosure relates to a Radioisotopes Generator System, for separation and purification for production of high specific activity alpha-emitting radioisotopes using an innovative experimental setup, for fields such as but not limited to: medical, radiopharmaceuticals, industrial applications, radioisotope power systems for space exploration, alpha voltaic cell, beta voltaic cell, nuclear battery as fuel for road, air and sea transportation vehicles, scientific research and agriculture and many other applications.

It is another embodiment, the present disclosure relates to a Radioisotopes Generator System, for separation and purification of alpha, Beta, Gamma/X ray-emitting radionuclides for nuclear medicine applications, such as diagnostic purposes such as medical imaging and therapeutic applications such as cancer treatment.

It is another embodiment, the present disclosure relates to a Radioisotopes Generator System, for separation and purification of radioisotopes such as ²³⁸Pu, which is used to power deep space missions.

It is another embodiment, the present disclosure relates to a Radioisotopes Generator System, for separation and purification of radioisotopes producing radionuclides with high specific activity produced by a transmutation technology using paramagnetic and excited state of mercury based compound having large internal resting energy, which reacts with the nucleus of target elements (any one of more elements of periodic table) and transmute target elements into many new elements including low mass, high mass, high density, rare earth, superheavy elements radionuclides with high specific activity.

It is another embodiment, the present disclosure relates to a Radioisotopes Generator System, for separation and purification of radioisotopes including producing a variety of alpha radionuclides, beta radionuclides and gamma/X ray radionuclides including low mass elements, high mass elements, high density elements, rare earth elements and superheavy elements from a variety of target elements from hydrogen to uranium and transuranic elements (any one or more elements of the periodic table). The target elements can be present either in molten state, liquid state, solid state and gaseous state or in combination thereof.

It is another embodiment, the present disclosure relates to a Radioisotopes Generator System, for separation and purification of radionuclides with high specific activity. In various aspects, the recovered radionuclides can be carrier free or essentially carrier free, e.g. having a specific activity of about 1 millicurie/microgram (mCi/μg) to 20 mCi/μg, about 1 mCi/μg to 10 mCi/μg, about 5 mCi/μg to 10 mCi/μg, about 5 mCi/μg to 15 mCi/μg, about 8 mCi/μg to 20 mCi/μg, or about 10 mCi/μg to 20 mCi/μg, about 0.0001 mCi/μg to 1 mCi/μg but not limited to it.

It is another embodiment, the present disclosure relates to a Radioisotopes Generator System, for separation and purification of desired radioisotope from the transmuted resultant target material is of paramount importance for therapeutic and medical applications as well as for radiological source preparation, and nuclear fuel reprocessing.

It is another embodiment, the present disclosure relates to a Radioisotopes Generator System, is to provide a process and a system to isolate and purify therapeutic alpha-emitting radioisotopes for treatment of acute myeloid leukemia (AML), breast cancer, ovarian cancer, glioblastomas, neuroblastomas, prostate cancer, bladder cancer, lymphoma, melanoma, neuroendocrine cancer, pancreatic cancer, blood-borne cancers.

It is another embodiment, the present disclosure relates to a Radioisotopes Generator System, for separation and purification of any divalent cations (e.g., the alkaline earths such as Ca(II), Sr(II) Ba(II), and Ra(II)) and trivalent cations (e.g., Y-90, the lanthanides, Lu-177, Sm-153, Er-169, Tb-161, Gd-159, Pr-143, Pm-149, Dr-165, Ho-166, Pr-142, Th-227, Ac-225, Ra-224, Ra-223, Bi-213, Bi-212, Pb-211, At-211), and Group 4 elements Ti, Zr, Hf, Th, from other materials.

It is another embodiment, the present disclosure relates to a Radioisotopes Generator System, is to provide a process and system for isolating and purifying such as Th-227, Ac-225, Ra-224, Ra-223, Bi-213, Bi-212, Pb-211, At-211 from transmuted resultant target material.

It is another embodiment, the present disclosure relates to a Radioisotopes Generator System, for separation and purification by using single resin bed to isolate and purify the Th-227, Ac-225, Ra-224, Ra-223, Bi-213, Bi-212, Pb-211, At-211, whereby mineral acid is required as the vehicle to transport and adsorb the Th-227, Ac-225, Ra-224, Ra-223, Bi-213, Bi-212, Pb-211, At-211 to the resin. An advantage of the invention is that radiopharmaceutically pure (e.g. greater than about 95 percent) Th-227, Ac-225, Ra-224, Ra-223, Bi-213, Bi-212, Pb-211, At-211 is produced in a very short time.

It is another embodiment, the present disclosure relates to a Radioisotopes Generator System, for separation and purification from homogeneous or heterogeneous bulk material, the method comprising dissolving the material to create a solution; contacting the solution with a resin so as to retain isotopes on the resin and generate an eluent containing target element; contacting the isotope-containing resin with acid of a first concentration to remove impurities (e.g., low mass elements, high mass elements, high density elements target element/s, any residual and other ions) from the resin; and contacting the isotope-containing resin with an acid of a second concentration to remove purified isotope from the resin.

It is another embodiment, the present disclosure relates to a Radioisotopes Generator System, for separation and purification of +2, +3, and +4 oxidation state moieties from other materials. For example, the invention provides a facile method for isolating and purifying hard trivalent oxidation state moieties, including, but not limited to Sc-47, Lu-177, Y-90, and Th-227, Ac-225, Ra-224, Ra-223, Bi-213, Bi-212, Pb-211, At-211 (“Hard” ions have small ionic radii and large positive ionic charges).

It is another embodiment, the present disclosure relates to a Radioisotopes Generator System, for separation and purification include mineral acids such as sulfuric acid, nitric acid and hydrochloric acid as the dissolution agent in the isotope liquid phase.

It is another embodiment, the present disclosure relates to a Radioisotopes Generator System, for separation and purification include mixtures of sulfuric acid with other acids (such as: hydrofluoric acid/sulfuric acid, nitric acid/sulfuric acid, hydrochloric acid/sulfuric acid, etc.) in the isotope liquor. Generally, the sulfuric is the primary component of any acid mixture. For example, the sulfuric acid is in excess to the hydrofluoric acid.

It is another embodiment, the present disclosure relates to a Radioisotopes Generator System, for separation and purification to produce a high purity (above 95 percent) yield of radioisotopes for medical and other applications. Purity relates to the high specific activity.

It is another embodiment, the present disclosure relates to a Radioisotopes Generator System, for separation and purification of medical radioisotopes from transmuted resultant target material. One such radioisotope is Ac-225. Actinium has a hard trivalent (+3) oxidation state.

It is another embodiment, the present disclosure relates to a Radioisotopes Generator System, for separation and purification of resultant target material produced by transmutation of target elements. The target elements may also be mixtures of molten, solid, gaseous and liquid phases. The target elements are transmuted using paramagnetic and excited state of mercury based compound having large internal resting energy for production of the radioisotopes of interest within the resultant target material.

It is another embodiment, the present disclosure relates to a Radioisotopes Generator System, for separation and purification of resultant target material produced by target elements such as pure 99.9% lead but not limited to it. Target element pure 99.9% lead is reacted with paramagnetic and excited state mercury-based compound for production of alpha-emitting radioisotopes such as Th-227, Ac-225, Ra-224, Ra-223, Bi-213, Bi-212, Pb-211, At-211.

It is another embodiment, the present disclosure relates to a Radioisotopes Generator System, for separation and purification of resultant target material containing alpha-emitting radioisotopes, are contacted with an acid, which is heated to above 60° C. but below the boiling point of water, so as to dissolve.

It is another embodiment, the present disclosure relates to a Radioisotopes Generator System, for separation and purification, wherein polar solvent such as water is added to the acid solution containing radioisotopes for adjusting viscosity of the solution, thereby making more free flowing solution. The initial loading of the resin is with a liquid phase of about 3 M or higher in acid concentration having pH about −0.5 to about −1.5.

It is another embodiment, the present disclosure relates to a Radioisotopes Generator System, for separation and purification, wherein the free flowing solution is preferable in facilitating the next step which is permeating a resin with the solution so as to begin with the separation process. The resin may be confined as in a column or free flowing, the analyte of interest is retained on the column such that the diluent comprises mainly target element such as lead.

It is another embodiment, the present disclosure relates to a Radioisotopes Generator System, for separation and purification wherein a single cation exchange resin column or bed is utilized in the process. The resin is then subjected to nitric acid of between about 3 M and about 8 M so as to begin extraction of impurities (e.g., low mass elements, high mass elements, high density elements, rare earth elements etc) from the alpha-emitting radioisotopes-containing resin.

It is another embodiment, the present disclosure relates to a Radioisotopes Generator System, for separation and purification, wherein second impurity-releasing wash is utilized using mild (about 5 M to about 8 M) hydrochloric acid. This creates a second impurities-ladened diluent and removes any residual nitric acid remaining from the first wash. However, if the final product is desirable in HNO₃, no HCl wash is required. Rather, a second wash using dilute HNO₃ (0.1 M) can be utilized after the initial 5-8 M HNO₃ wash.

It is another embodiment, the present disclosure relates to a Radioisotopes Generator System, for separation and purification, wherein impurities are washed away in the following order: The resin is first loaded with H₂SO₄ to remove extra lead, the resin is then permeated with HNO₃ to remove other element impurities in the resin and HCl is then added to the resin to remove the HNO₃ to get the resin media into HCl form so that the final product is solely in HCl, in those instances where the isotope is to be supplied in HCl.

It is another embodiment, the present disclosure relates to a Radioisotopes Generator System, for separation and purification, wherein heavily alpha-emitting radionuclide-ladened resin is permeated with relatively dilute acid (such as 0.15 M hydrochloric acid) to generate diluent comprising mainly solubilized alpha-emitting radionuclides. This renders the resulting resin suitable for recycling. The resulting, eluted such as Ac-225 is subjected to filtration such as by contacting the eluted Ac-225 with a sterile filter to provide pure (e.g., greater than 95 percent) Ac-225 diluent.

It is another embodiment, the present disclosure relates to a Radioisotopes Generator System, for separation and purification, wherein the transmuted resultant lead target material is dissolved using dilute nitric acid at concentration below about 2 M, and preferably between about 1 M and about 0.1 M. It is noteworthy that the lead removal steps require only mineral acid solutions.

It is another embodiment, the present disclosure relates to a Radioisotopes Generator System, for separation and purification, wherein the impurity extraction steps, post-transmuted resultant lead material removal, require relatively concentrated nitric acid (e.g., above about 3 M and below about 8 M) and hydrochloric acid (e.g., above about 3 M and below about 8 M), respectively.

It is another embodiment, the present disclosure relates to a Radioisotopes Generator System, for separation and purification, wherein initial heating of the transmuted resultant lead dissolving in mineral acid such as nitric acid, hydrochloric acid, sulfuric acid, the process can be done at any temperature and pressure. For example, temperatures between 0 C and 150 C are acceptable.

It is another embodiment, the present disclosure relates to a Radioisotopes Generator System for a method of fabricating a mercury based compound as a source of energy for transmutation of target elements for production of alpha-emitting radioisotopes, beta-emitting radioisotopes and gamma/X ray-emitting radioisotopes, wherein in the fabricated mercury based compound is paramagnetic and is present in an excited state, the method comprising for fabrication of mercury based compound having the steps of:
providing a pure mineral acid or a solution of mineral acid in a container;
adding liquid mercury to the container;
reacting the mercury and the mineral acid to form a mixture; and
drying the mixture to form the mercury based compound in powder form at a room temperature and environmental pressures,
   wherein the ratio of mineral acid to liquid mercury is selected from the range of between at least substantially 0.1:1 and 10:1 of mineral acid to mercury, wherein mineral acid is based on ml and liquid mercury is based on gram, and wherein the step of drying is carried out at a temperature selected in the range of 80° to 150° C. for a time selected in the range of 30 mins to 10 hours.

It is another embodiment, the present disclosure relates to a Radioisotopes Generator System, for separation and purification, wherein transmution of a target element so as to transmute portions of that resultant target material containing alpha-emitting radioisotopes, beta-emitting radioisotopes, gamma/X ray-emitting radioisotopes.

It is another embodiment, the present disclosure relates to a Radioisotopes Generator System, for separation and purification, wherein purifying the isotope by contacting the liquid to an ion exchange media, recycling the exchange media; and repeating the process.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electrons (Anions or cations).

The electron configuration of many ions is that of the closest noble gas to them in the periodic table. An anion is an ion that has gained one or more electrons, acquiring negative charge. A cation is an ion that has lost one or more electron, gaining positive charge.

It is another embodiment, the present disclosure relates to a Radioisotopes Generator System, for separation and purification of alpha-emitting radioisotopes and other isotopes from transmutation-produced material as paramagnetic material containing unpaired electrons, which can be recovered by donating electrons or accepting electrons using hydrometallurgy processes.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having less of electrons, which can be recovered by donating electrons using nucleophile material/elements.

It is another embodiment, the present disclosure relates to a Radioisotopes Generator System for a method of fabricating a mercury based compound as a source of energy for transmutation of target elements for production of alpha-emitting radioisotopes bonded with functional group complexes, organic compounds and carbon nanotubes and further separation and purification of alpha-emitting radioisotopes bonded with functional group complexes, organic compounds and carbon nanotubes from resultant target material.

It is another embodiment, the present disclosure relates to a Radioisotopes Generator System for a method of fabricating a mercury based compound as a source of energy for transmutation of target elements for production of beta-emitting radioisotopes bonded with functional group complexes, organic compounds and carbon nanotubes and further separation and purification of beta-emitting radioisotopes bonded with functional group complexes, organic compounds and carbon nanotubes from resultant target material.

It is another embodiment, the present disclosure relates to a Radioisotopes Generator System for a method of fabricating a mercury based compound as a source of energy for transmutation of target elements for production of gamma/X ray-emitting radioisotopes bonded with functional group complexes, organic compounds and carbon nanotubes and further separation and purification of gamma/X ray-emitting radioisotopes bonded with functional group complexes, organic compounds and carbon nanotubes from resultant target material.

In organic chemistry, an electrophile is an electron pair acceptor. Electrophiles are positively charged or neutral species having vacant orbitals that are attracted to an electron rich centre. It participates in a chemical reaction by accepting an electron pair in order to bond to a nucleophile. Because electrophiles accept electrons, they are Lewis acids. Most electrophiles are positively charged, have an atom that carries a partial positive charge, or have an atom that does not have an octet of electrons. They appear to attract electrons as well and seem to behave as though they are partially empty. These partially empty substances thus require an electron rich center, and thus they are filled. Electrophiles can be observed as electron-sensitive or photosensitive. The electrophiles are attacked by the most electron-populated part of one nucleophile.

A nucleophile is a chemical species that donates an electron pair to form a chemical bond in relation to a reaction. All elements, atoms, molecules or ions with a free pair of electrons or at least one pi bond can act as nucleophiles.

It is another embodiment, the present disclosure relates to a Radioisotopes Generator System, for separation and purification of alpha-emitting radioisotopes having energy range of 2 KeV to 9 MeV.

It is another embodiment, the present disclosure relates to a Radioisotopes Generator System, for separation and purification of beta-emitting radioisotopes having energy range of 2 KeV to 9 MeV

It is another embodiment, the present disclosure relates to a Radioisotopes Generator System, for separation and purification of gamma/X ray-emitting radioisotopes having energy range of 100 eV to 8 MeV.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having less of electrons, which can be recovered by donating electrons using electrophile elements/material.

A nucleophile is an electron donor (has an electron pair available for bonding) that bonds to an atom other than hydrogen. A base is an electron donor that bonds to hydrogen. The transformations that result from the action of bases or nucleophiles are numerous and varied.

These transformations follow a set of principles and can be categorized leading to a level of understanding that can be applied across many situations. The types of electrophiles, as well as the type of nucleophiles, can have an effect on the transformation. An electron donor is a chemical entity that donates electrons to another compound. It is a reducing agent that, by virtue of its donating electrons, is itself oxidized in the process.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electrons which can be recovered by donating electrons using nucleophile material/elements.

It is another embodiment, the present disclosure relates to a Radioisotopes Generator System, for separation and purification of alpha-emitting radioisotopes bonded with carbon nanotubes from resultant target material.

It is another embodiment, the present disclosure relates to a Radioisotopes Generator System, for separation and purification of beta-emitting radioisotopes bonded with carbon nanotubes from resultant target material.

It is another embodiment, the present disclosure relates to a Radioisotopes Generator System, for separation and purification of beta-emitting radioisotopes bonded with carbon nanotubes from resultant target material.

The overall energy balance (AE), i.e., energy gained or lost, in an electron donor-acceptor transfer is determined by the difference between the acceptor's electron affinity (A) and the ionization potential (I):

Electron acceptors are ions or molecules that act as oxidizing agents in chemical reactions. Electron donors are ions or molecules that donate electrons and are reducing agents. In the combustion reaction of gaseous hydrogen and oxygen to produce water (H₂O), two hydrogen atoms donate their electrons to an oxygen atom. In this reaction, the oxygen is reduced to an oxidation state of −2 and each hydrogen is oxidized to +1. Oxygen is an oxidizing agent (electron acceptor) and hydrogen is a reducing agent (electron donor).

Oxygen is the electron acceptor accepting electrons from organic carbon molecules; and as a result Oxygen is reduced to −2 oxidation state in H₂O and organic carbon is oxidized to +4 in CO₂.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electrons, which can be recovered using reducing agent.

Nitrate, sulfate, as well as iron and manganese oxides can act as electron acceptors.

Other common electron acceptors include peroxide and hypochlorite because they can oxidize organic molecules. Other common electron donors include antioxidants like sulfite.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electron, which can be recovered using oxidizing agent.

An oxidizing agent, or oxidant, gains electrons and is reduced in a chemical reaction.

Also known as the electron acceptor, the oxidizing agent is normally in one of its higher possible oxidation states because it will gain electrons and be reduced. Examples of oxidizing agents include halogens, potassium nitrate, and nitric acid.

A reducing agent, or reductant, loses electrons and is oxidized in a chemical reaction.

A reducing agent is typically in one of its lower possible oxidation states, and is known as the electron donor. A reducing agent is oxidized, because it loses electrons in the redox reaction. Examples of reducing agents include the earth metals, formic acid, and sulfite compounds.

Common Oxidizing agents: O2, O3, F2, Br2, H2SO4

Common Reducing agents: H2, CO, Fe, Zn, Al, Li

When AA loses electrons, it is oxidized, and is thus a reducing agent.

When BB gains electron, it is reduced, and is thus an oxidizing agent.

AA is oxidized and BB is reduced.

In a redox reaction, there is always an oxidizing and reducing agent.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electrons which can be recovered using redox process.

It is another embodiment, the present disclosure relates to a Radioisotopes Generator System, for separation and purification of alpha-emitting radioisotopes bonded with functional group complexes.

It is another embodiment, the present disclosure relates to a Radioisotopes Generator System, for separation and purification of beta-emitting radioisotopes bonded with functional group complexes.

It is another embodiment, the present disclosure relates to a Radioisotopes Generator System, for separation and purification of gamma/X ray-emitting radioisotopes bonded with functional group complexes.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electrons which can be recovered using Free radicals as electron donor.

It is another embodiment, the present disclosure relates to a Radioisotopes Generator System, for separation and purification of alpha-emitting radioisotopes and other isotopes from transmutation-produced material as paramagnetic material containing unpaired electrons obtained from of any one or more elements of the periodic table, present in solid state or liquid state or gaseous state, having either excess of electrons or less of electrons, which can be recovered using Free radicals as electron acceptor.

It is another embodiment, the present disclosure relates to a Radioisotopes Generator System, for separation and purification of alpha-emitting radioisotopes having energy of 1-7 MeV for application of therapeutic treatment, nuclear medicine, Targeted Alpha Therapy (TAT), nuclear batteries, and nuclear fuel, industrial applications such as Ac-5-6 MeV, Am 5-6 MeV, At 5-7 MeV, Bk 5-6 MeV, Bi 4-7 MeV, Cf 5-7 MeV, Cm 4-7 MeV, Dy 2-3 MeV, Es 6-7 MeV, Fm 6-7 MeV, Fr 6-7 MeV, Gd 2-4 MeV, Hf 2-3 MeV, Md 6-7 MeV, Nd 1-2 MeV, NP 4-5 MeV, Os 2-3 MeV, Pt 3-4 MeV, Pu 4-6 MeV, Pa 4-6 MeV, Ra 4-6 MeV, Rn 5-7 MeV, Sm 2-3 MeV, Th 3-7 MeV, U 4-6 MeV.

It is another embodiment, the present disclosure relates to a Radioisotopes Generator System, for separation and purification of alpha-emitting radioisotopes for obtaining therapeutically effective amounts of Ac-225, Ra-224, At-211, Pb-212 and/or Bi-213.

It is another embodiment, the present disclosure relates to a Radioisotopes Generator System, for producing solutions comprising alpha particle emitting radioactive isotopes. Such alpha particle emitting radioactive isotopes may be useful in targeted alpha therapy (“TAT”). For instance, targeted alpha therapy cancer treatments may be used in radioimmunotherapy methods. In this regard, the methods and products described herein generally relate to alpha particle emitting radioactive isotopes and elements capable of generating such alpha particle emitting radioactive isotopes via radioactive decay.

It is another embodiment, the present disclosure relates to a Radioisotopes Generator System, for producing solutions comprising alpha particle emitting isotopes and generators thereof, comprising therapeutic amounts of alpha emitting particle isotopes Pb-212, Bi-213, and Ac-225. Furthermore, the methods may be useful in producing solutions comprising therapeutic amounts of Ra-228, Th-228, and/or Ra-224, any of which may be used to generate Pb-212. Additionally, the methods described herein may be useful in producing solutions comprising therapeutic amounts of Ac-225, and/or Ra-225, either of which may be used to generate Bi-213. In another aspect, Ac-225 itself may be used as an alpha particle emitting radioactive isotope. In this regard, Ac-225 may decay via three subsequent alpha particle emissions to Bi-213, which itself will undergo a fourth alpha particle emission to Pb-209.

It is another embodiment, the present disclosure relates to a Radioisotopes Generator System, where in “adsorbent” is a material that adsorbs another material. “Adsorb” and the like means to adhere to the surface of an adsorbent, such as by chemical, physical and/or electrical attraction. An adsorbed material is a material that adheres to the surface of an adsorbent due to adsorption. An adsorbed material may be removed from the surface of the adsorbent, for instance, by an appropriate solvent and/or an appropriate solution (e.g., an extraction solution) having an appropriate pH, i.e., a solvent/solution may desorb an adsorbed material (e.g., a divalent cation) from the adsorbent (e.g., a crown ether material). In another aspect, the surface may include molecules (e.g., a crown ether) tethered (e.g., via chemical bonding) to the surface of an adsorbent, and such molecules are considered as being a part of the surface herein.

It is another embodiment, the present disclosure relates to a Radioisotopes Generator System, wherein the adsorbent may be contacted with an acidic wash solution to remove at least some of actinide elements from the adsorbent. An acidic wash solution effluent comprising the acidic wash solution and at least some actinides (e.g., actinide element cations) may be discharged from the packed column and recovered.

It is another embodiment, the present disclosure relates to a Radioisotopes Generator System, wherein solutions may be provided to an inlet of the packed column and an effluent therefrom may be discharged from the outlet and collected. Suitable materials for the packed column include glass (e.g., silica glass, borosilicate glass, etc.), and polymer materials. Some suitable polymer materials may include polymethylpentene, polyethylene, polyvinylchloride, polyvinylchloride free of plasticizing agents, among others.

It is another embodiment, the present disclosure relates to a Radioisotopes Generator System, wherein an adsorbent has a selectivity towards divalent cation elements. For instance, divalent cations of radium and/or Actinium may be selectively removed from one or more of the solutions described herein using a suitable adsorbent.

It is another embodiment, the present disclosure relates to a Radioisotopes Generator System, wherein the adsorbents may comprise a stationary phase (e.g., a solid material that is insoluble in the solution being exposed). The stationary phase may comprise other materials tailored to facilitate the selective adsorption of divalent cations. The other materials may be tethered to the stationary phase (e.g., via covalently bonds), or otherwise incorporated into the stationary phase. In some embodiments, one or more of the adsorbents comprises one or more macrocyclic polyether materials. Such macrocyclic polyether materials may facilitate selective adsorption of divalent cations. In some embodiments, the one or more macrocyclic polyether materials comprise at least one crown ether, such as 18-crown-6 crown ether materials, and/or 21-crown-7 crown ether materials, among others. Further, various combinations of materials tailored to facilitate the selective adsorption of divalent cations may be used (e.g., combinations of crown ethers).

It is another embodiment, the present disclosure relates to a Radioisotopes Generator System, wherein a solution comprises a therapeutically effective amount of alpha particle emitting radioactive isotopes (e.g., Pb-212, Bi-213, Ra-224Ac-225, At-211 or any other suitable alpha particle emitting radioactive isotopes capable of being used in a medical setting).

Certain beta-particle emitters have long been regarded as effective in the treatment of cancers. More recently, alpha-emitters have been targeted for use in anti-tumour agents. Alpha-emitters differ in several ways from beta-emitters, for example, they have higher energies and shorter ranges in tissues. The radiation range of typical alpha-emitters in physiological surroundings is generally less than 100 μm, the equivalent of only a few cell diameters. This relatively short range makes alpha-emitters especially well-suited for treatment of tumours including micrometastases, because when they are targeted and controlled effectively, relatively little of the radiated energy will pass beyond the target cells, thus minimising damage to the surrounding healthy tissue. In contrast, a beta-particle has a range of 1 mm or more in water.

It is another embodiment, the present disclosure relates to a Radioisotopes Generator System, wherein the energy of alpha-particle radiation is high compared to that from beta-particles, gamma rays and X-rays, typically being 5-8 MeV, or 5 to 10 times higher than from beta-particle radiation and at least 20 times higher than from gamma radiation. The provision of a very large amount of energy over a very short distance gives alpha-radiation an exceptionally high linear energy transfer (LET) when compared to beta- or gamma-radiation. This explains the exceptional cytotoxicitiy of alpha-emitting radionuclides and also imposes stringent demands on the level of control and study of radionuclide distribution necessary in order to avoid unacceptable side effects due to irradiation of healthy tissue.

1. A method for recovering at least one radionuclide resulting from transmutation of a target material, wherein a product enriched with the at least one radionuclide is extracted after transmutation from the target material in a mass separation process comprising at least one of the following operations:
selective adsorption of the at least one radionuclide to a solid support and desorption of the at least one absorbed radionuclide by evaporation; or
electrochemical separation of the at least one radionuclide by electrochemically depositing either the at least one radionuclide or the target material on a metallic electrode; or
removing the target material by high temperature sublimation under vacuum or in an inert atmosphere, if the at least one radionuclide is less volatile than the target material.

2. A The method according to claim 1, wherein the separation operation is reiterated with the material extracted in the preceding iteration as the starting material in the subsequent iteration.

3. The method according to claim 1, wherein the target material is in one of a molten condition, gaseous form, liquid form, solid form, ion form, salt form, or in an at least partial combination thereof.

4. The method according to claim 1, wherein the at least one radionuclide is actinium 225.

5. The method according to claim 4, wherein at least one further radionuclide selected from radium 223 or radium 224 or radium 225 is co-extracted with actinium 225.

6. The method according to claim 1, wherein the target material is a mercury-based compound in an excited state.

7. A method for the production of a radioisotope by transmutation of a target material, wherein an excited state mercury-based compound is used as a source of energy for the transmutation of the target material.

8. The method according to claim 7, wherein the target material is at least one of or a combination of the elements in the periodic system of elements including the transuranic elements.

9. The method according to claim 7, wherein the transmutation is carried out in the molten state of the target material in contact with the mercury-based compound.

10. The method according to claim 7, wherein radioisotopes are separated from the target material after transmutation.

11. The method according to claim 10, wherein separation is carried out by chemical or radiochemical treatment, in particular including ion-exchange, liquid chromatography resin chromatography, (dry or wet) distillation, sublimation, precipitation and extraction, in particular solid phase extraction (SPE), liquid-liquid extraction (LLE).

12. The method according to claim 7, wherein the radioisotope obtained by transmutation is purified by radio chromatographic separation.

13. The method according to claim 7, wherein the carrier free isotope is obtained in atomic or ionic form or as a molecular ion.

14. An apparatus for the production of a radioisotope by transmutation of a target material through a material in a nuclear excited state as a source of energy for the transmutation, the apparatus comprising a melting furnace for receiving the target and excited state materials and providing a heating temperature that is equal to or higher than the melting temperature of the target material.

15. The apparatus according to claim 14, wherein the melting furnace is a vacuum melting furnace.
